(19) United States
(12) Patent Application Publication
(10) Pub. No.: US 2021/0371687 A1
(43) Pub. Date: Dec. 2, 2021

(54) White Ink Composition And Printing Method

(71) Applicant: Seiko Epson Corporation, Tokyo (JP)

(72) Inventor: Kohei ISHIDA, Matsumoto (JP)

(21) Appl. No.: 17/335,109

(22) Filed: Jun. 1, 2021

(30) Foreign Application Priority Data
Jun. 2, 2020 (JP) 2020-096026

(51) Int. Cl. C09D 11/322; C09D 11/36; C09D 11/54; C09D 11/102; C09D 11/107; C08K 3/22; C08L 33/08; C08L 75/04; C08L 71/02; C08K 5/053; C08K 5/20; B41J 2/21; B41J 11/00; B41M 5/00

(52) U.S. Cl. CPC C09D 11/322; C08L 2205/18; C09D 11/54; C09D 11/102; C09D 11/107; C08K 3/22; C08L 33/08; C08L 75/04; C08L 71/02; C08K 5/053; C08K 5/20; B41J 2/2107; B41J 11/002; B41M 5/0017; C08K 2003/2241; C09D 11/36

(57) ABSTRACT

An aqueous white ink jet ink composition is provided for printing in which a treatment liquid containing a flocculant is applied onto a poorly absorbent or non-absorbent printing medium. The white ink composition contains a white pigment, a nonionic dispersant adapted to disperse the white pigment, and a fixing resin.

The present application is based on, and claims priority from JP Application Serial Number 2020-096026, filed Jun. 2, 2020, the disclosure of which is hereby incorporated by reference herein in its entirety.

### BACKGROUND

### 1. Technical Field

The present disclosure relates to a white ink composition and a printing method.

### 2. Related Art

A known ink jet printing method has been used for printing images on printing media by ejecting tiny ink droplets through the nozzles of the ink jet head of an ink jet printing apparatus. Such an ink jet printing method has been being considered for printing poorly absorbent or non-absorbent printing media, such as polyolefin films. JP-A-2015-147405 discloses a printing method using a reaction liquid and a white ink. In this method, the flocculant contained in the reaction liquid is intended to increase the color developability of the white ink.

In some cases, a non-white image and a white image are superimposed on each other on a printing medium. In this instance, the white image layer acts as an undercoat layer that can hide the background of the non-white image. High-quality image formation can be expected.

For superimposing a non-white image and a white image on each other on a poorly absorbent or non-absorbent printing medium, a treatment liquid containing a flocculant may be used to further improve image quality. However, the treatment liquid can improve the non-white image quality but reduce the filling degree of the white background image.

### SUMMARY

An aspect of the present disclosure provides an aqueous white ink jet ink composition used for printing performed by applying a treatment liquid containing a flocculant onto a poorly absorbent or non-absorbent printing medium. The white ink composition contains a white pigment, a nonionic dispersant adapted to disperse the white pigment, and a fixing resin.

Another aspect of the present disclosure provides a printing method including a white ink application step of applying the white ink composition onto a poorly absorbent or non-absorbent printing medium by an ink jet method, and a treatment liquid application step of applying the treatment liquid onto the printing medium.

### BRIEF DESCRIPTION OF THE DRAWINGS

FIG. 1 is a schematic diagram of an ink jet printing apparatus used in an embodiment of the present disclosure.

FIG. 2 is a schematic view of the carriage and its vicinity of an ink jet printing apparatus used in an embodiment of the present disclosure.

FIG. 3 is a block diagram of an ink jet printing apparatus used in an embodiment of the present disclosure.

FIG. 4 is a schematic sectional diagram of a portion of a line printing apparatus.

### DESCRIPTION OF EXEMPLARY EMBODIMENTS

Some embodiments of the present disclosure will now be described. The following description illustrates some exemplary embodiments of the subject matter of the present disclosure. The subject matter of the present disclosure is not limited to the following embodiments, and various modifications may be made within the scope and spirit of the disclosure. Not all of the components or members disclosed in the following embodiments are necessarily essential for the subject matter disclosed herein.

### 1. White Ink Composition

The white ink composition disclosed herein contains a white pigment and is an aqueous ink jet ink. The white ink composition is used for printing in which a treatment liquid containing a flocculant is applied onto a printing medium.

The white ink composition contains a white pigment, a nonionic dispersant capable of dispersing the white pigment, and a fixing resin.

This white ink composition can produce well-filled white images. In addition, the white ink composition can be consistently ejected, and the final printed images can be resistant to lamination and rubbing.

The white ink composition may be used for printing in which a non-white ink composition and a treatment liquid containing a flocculant are applied onto a printing medium. The treatment liquid may contain a flocculant capable of flocculating one or more constituents of the non-white ink composition.

### 1.1. White Pigment

The white ink composition contains a white pigment. Common white pigments include metal compounds, such as metal oxides, barium sulfate, and calcium carbonate. Examples of the metal oxides include titanium dioxide, zinc oxide, silica, alumina, and magnesium oxide. Alternatively, the white pigment may be hollow particles, and known hollow particles can be used.

Titanium dioxide is a typical white pigment, and available examples thereof include TIPAQUES (registered trademark), such as CR-50-2, CR-57, CR-58-2, CR-60-2, CR-60-3, CR-Super-70, CR-90-2, CR-95, CR953, PC-3, PF-690, PF-691, PF-699, PF-711, PF-728, PF-736, PF-737, PF-739, PF-740, PF-742, R-980, and UT-771 (all produced by Ishihara Sangyo Kaisha).

In some embodiments, titanium dioxide is used as the white pigment from the viewpoint of increasing the whiteness and rub resistance of the white image. A white pigment may be used independently, or two or more white pigments may be used in combination.

The volume average particle size (D50) of the white pigment may be 30.0 nm to 600.0 nm, for example, 100.0 to 500.0 nm or 150.0 nm to 400.0 nm. The white pigment having such a volume average particle size is not likely to settle down, and, accordingly, the dispersion thereof can be stable. Also, such a white pigment, when used in an ink jet printing apparatus, is not likely to clog the nozzles of the ink jet printing apparatus. In addition, the white pigment having a volume average particle size in the above-mentioned ranges can favorably hide the image background and increase the visibility of the final printed image.

The volume average particle size of the white pigment can be measured with a particle size distribution analyzer. For example, a particle size distribution analyzer using dynamic light scattering (for example, any one of NANOTRAC series manufactured by MicrotracBEL) may be used. The volume average particle size used herein represents D50.

The “white” mentioned herein for the white ink composition and white pigment does not strictly mean perfect white and may be chromatic white, achromatic white, or glossy white, provided that the color is visually recognized as white. The white ink or pigment may be a commercial product whose name suggests a white ink or pigment.

In a quantitative sense, the “white” of a printed image is not only a color having a lightness L* of 100 in the CIELAB color system but also a color having a lightness L* of 60 to 100 and saturation/chroma parameters a* and b* of −10 to +10 each.

For example, when the surface of a transparent film is sufficiently covered by being printed with such a white ink composition, the lightness L* and the saturation/chroma parameters a* and b* of the printed portion, measured with a spectrophotometer according to the CIELAB color scale, are in the above ranges. In this instance, the amount of the white ink composition applied to sufficiently cover the transparent film surface may be, for example, 15 mg/inch². In some embodiments, the color of the printed portion may satisfy 80≤L*≤100, −4.5≤a*≤2, and −10≤b*≤2.5. The transparent film used as the printing medium may be, for example, LAG Jet E-1000ZC (manufactured by Lintec Corporation). The color of the printed ink may be measured, for example, by using a spectrophotometer according to the CIELAB color scale, for example, Spectrolino (manufactured by GretagMacbeth), with a D50 light source at an observation viewing angle of 2° and a DIN NB density with no filter on an Abs basis in a measurement mode of Reflectance.

The term “non-white” used herein for the non-white ink composition and pigment refers to colors other than the above-described “white”.

The white pigment solid content in the white ink composition may be 0.5% to 20.0%, for example, 1.0% to 20.0%, relative to the total mass of the white ink composition. In some embodiments, it may be 5.0% to 20.0% or 10.0% to 20.0%. The white ink composition with such a white pigment content can form highly color-developed images that can sufficiently hide the background of the final printed image. Also, when the white pigment content is in the above ranges, the white pigment can be more favorably dispersed in the ink composition.

Desirably, the white pigment is stably dispersed in the dispersion medium. Accordingly, the white ink composition disclosed herein contains a dispersant. The dispersant may be, for example, a resin dispersant and is selected from among dispersants that can stably keep the white pigment dispersed in the white ink composition. In an embodiment, the white pigment may be surface-modified by oxidizing or sulfonating the surfaces of the pigment particles with ozone, hypochlorous acid, fuming sulfuric acid, or the like for use as a self-dispersible pigment. In this instance as well, the white ink composition contains a dispersant.

### 1.2. Dispersant

The white ink composition disclosed herein contains a dispersant capable of dispersing the white pigment. The dispersant is nonionic. In the embodiments of the present disclosure, dispersants commonly considered nonionic are nonionic dispersants. The dispersant is capable of dispersing the white pigment and, in the white ink composition, may be in contact with the peripheries of the white pigment particles to form larger particles with the white pigment.

Dispersant compounds not having any anionic or cationic groups are considered nonionic.

For a dispersant compound containing anionic or cationic groups in a very small proportion in the molecule, the dispersant can be considered to be nonionic, provided that a solution or dispersion liquid of the dispersant in water or a dispersion liquid of the white pigment dispersed with the dispersant is nonionic as a whole. The zeta potential of such a solution or dispersion liquid is relatively low in absolute value. For example, the zeta potential is −30 mV to +30 mV, and may be −20 mV to +20 mV, for example, −10 mV to +10 mV or −5 mV to +5 mV. Also, dispersants sold as nonionic products can be dealt with as nonionic.

The zeta potential of a dispersion liquid of the white pigment with a dispersant can be measured by a usual technique with, for example, a zeta-potential & particle size analyzer ELSZ-2 (manufactured by Otsuka Electronics) or Zetasizer Nano ZS (manufactured by Malvern).

Also, the acid value of the nonionic dispersant may be 10.0 mg KOH/g or less or 8.0 mg KOH/g or less. In some embodiments, a nonionic dispersant having an acid value of 5.0 mg KOH/g or less may be selected. The acid value may be 0 mg KOH/g or more.

The acid value of a dispersant is the mass by mg of potassium hydroxide (KOH) required to neutralize the acid in 1 g of the dispersant and can be measured by potentiometric titration using a known titrator. For measuring the acid value of a dispersant, for example, a solution of the dispersant in an ethanol/toluene mixed solvent is measured by titrating a KOH solution with an automatic potentiometric titrator AT-610 (manufactured by Kyoto Electronics Manufacturing).

Nonionic dispersants with acid values in the above ranges can improve the filling degree of the white image and more favorably disperse the white pigment in the ink composition.

The dispersant may be a low-molecular-weight compound or a polymer. In some embodiments, a polymer dispersant may be used. The molecular weight of the polymer dispersant may be 2,000 or more, for example, 5,000 or more or 10,000 or more. The upper limit of the molecular weight may be, but is not limited to, 200 thousand or less or 100 thousand or less. For the low-molecular weight dispersant, the molecular weight may be less than 2,000. For example, it may be, but is not limited to, 100 to 1,500.

The dispersant may be a water-soluble resin, and examples of such a dispersant include vinyl acetate-(meth)acrylic ester copolymer and other (meth)acrylic ester-based resins; styrene-α-methylstyrene-(meth)acrylic ester copolymer and other styrene-(meth)acrylic ester-based resins; urethane resins that are straight or branched polymers (resins) containing urethane bonds formed by a reaction of an isocyanate group with a hydroxy group and may or may not have crosslinked structures; polyvinyl alcohols; and vinyl acetate-maleic ester copolymers. In some embodiments, the dispersant may be a copolymer of a monomer having a hydrophobic functional group and a monomer having a hydrophilic functional group, or a polymer formed of a monomer having both a hydrophobic functional group and a hydrophilic functional group. The copolymer may be a random copolymer, a block copolymer, an alternating copolymer, or a graft copolymer.

Commercially available styrene-based resin dispersants include, for example, DISPERBYK-190 (produced by BYK), DISCOL N-509 (produced by Dai-ichi Kogyo Seiyaku), and K-30 (polyvinylpyrrolidone produced by Nippon Shokubai).

Commercially available urethane resin dispersants include BYK-182, BYK-183, BYK-184, and BYK-185 (all produced by BYK).

The nonionic dispersant may have a polyoxyalkylene structure, a nitrogen-containing structure, or a polyol structure as a hydrophilic portion.

The polyoxyalkylene structure may be a polyoxyethylene structure or a polyoxypropylene structure.

The nitrogen-containing structure may be polyamide, polyamine, or polyvinylpyrrolidone.

For the polyol structure, any structure having many hydroxy groups in the molecule can be selected. For example, the nonionic dispersant having such a structure can be a compound having (substituted with) hydroxy groups on the main chain of the molecule or a compound having hydroxy groups on a side chain of the molecule. The compound with hydroxy groups on a side chain may be a polymer of vinyl or acrylic monomers having a hydroxy group. The compound with hydroxy groups on the main chain may be polyvinyl alcohol.

Dispersants having polyoxyalkylene structures, nitrogen-containing structures, or polyol structures can more favorably disperse the white pigment.

The dispersant is used in a proportion of 10.0% to 150.0%, for example, 15.0% to 120.0%, 20.0% to 100.0%, or 30.0% to 90.0%, to the mass of the white pigment. Also, when the dispersant is used in such a proportion, white images can be sufficiently color-developed, and the white pigment can disperse favorably.

### 1.3. Fixing Resin

The white ink composition of the present disclosure contains a fixing resin. The fixing resin fixes the white pigment to the printing medium, thus increasing the resistance of the white image to rubbing and lamination.

The fixing resin of the white ink composition may be a water-soluble resin that is to be present dissolved in the white ink composition or a dispersible resin that is to be present in the form of resin particles dispersed in the white ink composition. The water-soluble resin is soluble in the solvent in the white ink composition and is different from the dispersant used for dispersing the white pigment. The water-soluble fixing resin is not a part of the particles, including the pigment particles, in the white ink composition and is present dissolved in the ink solvent.

The dispersible fixing resin, or fixing resin particles, is different from the resin particles contacting the white pigment to form larger particles in the white ink composition.

Examples of the fixing resin include polyurethane resin, acrylic resin, polyester resin, and polyether resin.

The water-soluble fixing resin may be a polymer having a structure including hydrophilic portions in a larger proportion. For example, the water-soluble resin is such that when a mixture of 1% by mass of the resin and water is stirred, the resin solids do not remain in the mixture or the mixture is not cloudy.

PLASCOAT series Z-221, Z-446, Z-561, Z-730, and Z-687 (produced by Goo Chemical) are examples of the water-soluble polyester fixing resin.

Examples of the fixing resin include urethane resin, acrylic resin (including styrene-acrylic resin), fluorene resin, polyolefin resin, rosin-modified resin, terpene resin, polyester resin, polyamide resin, epoxy resin, vinyl chloride resin, vinyl chloride-vinyl acetate copolymers, and ethylene vinyl acetate resin. In some embodiments, urethane resin, acrylic resin, polyolefin resin, and polyester resin may be used. Such resins are often used in the form of emulsion but may be in powder. Such a fixing resin is to be dispersed as resin particles in the ink composition. The fixing resin may be an individual resin or a combination of two or more resins.

Urethane resin is a generic term for resins containing urethane linkages. The urethane resin used herein may contain other linkages or bonds in the main chain in addition to the urethane linkages, and examples of such a urethane resin include polyether-type urethane resins containing ether linkages, polyester-type urethane resins containing ester linkages, and polycarbonate-type urethane resins containing carbonate linkages. Commercially available urethane resins may be used, and examples thereof include SUPERFLEX series 460, 460s, 840, E-2000, and E-4000 (all produced by Dai-ichi Kogyo Seiyaku), RESAMINE series D-1060, D-2020, D-4080, D-4200, D-6300, and D-6455 (all produced by Dainichiseika Color & Chemicals Mfg.), TAKELAC series WS-6021 and W-512-A-6 (both produced by Mitsui Chemicals), SANCURE 2710 (produced by Lubrizol), and PERMARIN UA-150 (produced by Sanyo Chemical Industries).

Acrylic resin is a generic term for polymers obtained by polymerizing one or more species of acrylic monomer, such as (meth)acrylic acid and (meth)acrylic acid esters. Acrylic resins may be homopolymers produced from one or more species of acrylic monomer or copolymers produced from one or more species of acrylic monomer and other monomers. Acrylic-vinyl resin, a copolymer of an acrylic monomer and a vinyl monomer, is one example of such a copolymer. The vinyl monomer may be styrene.

Other acrylic monomers include acrylamide and acrylonitrile. Commercially available acrylic resin emulsions may be used as the acrylic resin, and examples thereof include FK-854 (produced by CHIRIKA), MOWINYL 952B and MOWINYL 718A (both produced by Japan Coating Resin Corporation), NIPOL LX852 and NIPOL LX874 (both produced by Nippon Zeon).

The acrylic resin used herein may be a styrene-acrylic resin described below. The term (meth)acrylic (or (meth)acrylate) used herein refers to at least one of acrylic (or acrylate) and methacrylic (or methacrylate).

Styrene-acrylic resin is a type of copolymer produced from one or more species of styrene monomer and one or more species of acrylic monomer, and examples thereof include styrene-acrylic acid copolymers, styrene-methacrylic acid copolymers, styrene-methacrylic acid-acrylate copolymers, styrene-α-methylstyrene-acrylic acid copolymers, and styrene-α-methylstyrene-acrylic acid-acrylate copolymers. Some styrene-acrylic resins are commercially available, and examples thereof include JONCRYL series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all produced by BASF), MOWINYL series 966A and 975N (both produced by Japan Coating Resin Corporation), and VINYBLAN 2586 (produced by Nissin Chemical Industry).

Polyolefin resin is a type of resin having a skeleton containing an olefin, such as ethylene, propylene, or butylene, and a known polyolefin resin may be used. Commercially available polyolefin resins may be used, and examples thereof include ARROWBASE series CB-1200 and CD-1200 (both produced by Unitika).

The fixing resin is commercially available in an emulsion form, and examples thereof include Micro Gel E-1002 and Micro Gel E-5002 (both styrene-acrylic resin emulsions produced by Nippon Paint); VONCOAT 4001 (acrylic resin emulsion produced by DIC) and VONCOAT 5454 (styrene-acrylic resin emulsion produced by DIC); Polysol series AM-710, AM-920, AM-2300, AP-4735, AT-860, and PSASE-4210E (all acrylic resin emulsions), Polysol AP-7020 (styrene-acrylic resin emulsion), Polysol SH-502 (vinyl acetate resin emulsion), Polysol series AD-13, AD-2, AD-10, AD-96, AD-17, and AD-70 (all ethylene-vinyl acetate resin emulsions), and Polysol PSASE-6010 (ethylene-vinyl acetate resin emulsion) (all polysols produced by Showa Denko); Polysol SAE1014 (styrene acrylic resin emulsion produced by Zeon Corporation); SAIVINOL SK-200 (acrylic resin emulsion produced by Saiden Chemical Industry); AE-120A (acrylic resin emulsion produced by JSR); AE373D (carboxy-modified styrene-acrylic resin emulsion produced by Emulsion Technology Co., Ltd.); SEIKADYNE 1900W (ethylene-vinyl acetate resin emulsion produced by Dainichiseika Color & Chemicals); VINYBLAN 2682 (acrylic resin emulsion), VINYBLAN 2886 (vinyl acetate-acrylic resin emulsion), and VINYBLAN 5202 (acetic acid-acrylic resin emulsion) (all VINYBLANs produced by Nissin Chemical Industry); ELITEL series KA-5071S, KT-8803, KT-9204, KT-8701, KT-8904, and KT-0507 (all polyester resin emulsions produced by Unitika); HYTEC SN-2002 (polyester resin emulsion produced by Toho Chemical Industry); TAKELAC series W-6020, W-635, W-6061, W-605, W-635, and W-6021 (all urethane resin emulsions produced by Mitsui Chemicals); SUPERFLEX series 870, 800, 150, 420, 460, 470, 610, and 700 (all urethane resin emulsions produced by Dai-ichi Kogyo Seiyaku); PERMARIN UA-150 (urethane resin emulsion produced by Sanyo Chemical Industries); SANCURE 2710 (urethane resin emulsion produced by Lubrizol); NeoRez series R-9660, R-9637, and R-940 (all urethane resin emulsions produced by Kusumoto Chemicals); ADEKA Bon-Tighter series HUX-380 and 290K (urethane resin emulsion produced by ADEKA); MOWINYL 966A, MOWINYL 7320, and MOWINYL 7470 (all produced by Nippon Synthetic Chemical Industry); JONCRYL series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (all produced by BASF); NK Binder R-5HN (produced by Shin-Nakamura Chemical); HYDRAN WLS-210 (non-crosslinked polyurethane produced by DIC); and JONCRYL 7610 (produced by BASF).

The fixing resin may have a glass transition temperature (Tg) of −50° C. to 200° C., for example, 0° C. to 150° C. or 50° C. to 100° C. In some embodiments, a fixing resin having a glass transition temperature of 50° C. to 80° C. may be used. Using such a fixing resin increases durability and reduces clogging. The glass transition temperature can be measured with, for example, a differential scanning calorimeter DSC 7000 manufactured by Hitachi High-Tech Science in accordance with JIS K7121 (Testing Method for Transition Temperatures of Plastics).

The volume average particle size of the fixing resin may be 10 nm to 300 nm, for example, 30 nm to 300 nm, 30 nm to 250 nm, or 40 nm to 220 nm. The volume average particle size can be measured in the same manner as described above.

For the dispersible fixing resin that is to be present resin particles in the ink composition, the change in volume average particle size is 50.0% or less when the resin is mixed with calcium acetate solution. For determining the change in particle size, the volume average particle size of the fixing resin in 10 mass % dispersion liquid of the fixing resin is used as the denominator. Then, 5 mass % aqueous solution of calcium acetate is mixed with 10 mass % fixing resin dispersion liquid in a mass ratio of 1:10. Hence, calcium acetate and the solid fixing resin particles are mixed in a mass ratio of 5:100. The volume average particle size in this mixture is measured, and the difference between the volume average particle sizes before and after mixing is calculated. The distance is used as the numerator. The change in volume average particle size is defined by multiplying the value of numerator/denominator by 100 and represented by a percentage. More specifically, it is represented by the following arithmetic expression:

|(particle size after mixing with calcium acetate solution)−(particle size in 10 mass % fixing resin dispersion liquid)|/(particle size in 10 mass % fixing resin dispersion liquid)×100(%)

The mixture is sufficiently stirred, for example, for 1 minute. Immediately after stirring, the particle size is measured, for example, within 1 minute. The measurement is performed in the same manner as the volume average particle size measurement of the pigment, obtaining D50.

In some embodiments, the change in volume average particle size is 40% or less and may be 30% or less, 20% or less, 10% or less, or 5% or less. The lower limit is 0%. Using such fixing resin particles further increases the filling degree of the white image and the resistance to lamination and rubbing.

Also, the fixing resin particles are less likely to aggregate in the white ink composition and contribute to forming sufficiently filled images.

In some embodiments, the fixing resin is nonionic and dispersible. The term nonionic used for the fixing resin has the same meaning as the term nonionic used for the nonionic dispersant. For determining whether the fixing resin is nonionic, the fixing resin is dissolved or dispersed in water as in the case of the dispersant, which is dissolved or dispersed in water.

When a dispersible fixing resin is in water, the liquid is a dispersion liquid of the fixing resin particles. In this instance, the fixing resin particles may be dispersed with a dispersant or may be self-dispersible. When a dispersant is used, the entire fixing resin dispersion liquid includes the dispersant, and the dispersant is a part of the fixing resin dispersion liquid. Hence, a nonionic dispersion liquid prepared by dispersing a fixing resin with a nonionic dispersant can be considered to be a dispersion liquid of a nonionic fixing resin.

The fixing resin may be anionic. Anionic fixing resins are other than the above-described nonionic fixing rein, and whose dispersion liquid or solution in water is anionic.

The anionic fixing resin may be a resin that is anionic itself or a resin whose dispersion with an anionic dispersant is anionic. Dispersion liquids that are anionic as a whole are considered to be those of anionic fixing resins.

An anionic fixing resin has an anionic group. The anionic fixing resin may have an acid value.

The insoluble, dispersible fixing resin may be in the form of a dispersion of self-dispersible resin particles having an acid value. The acid value of the fixing resin particles is desirably low to the extent that the reactivity does not increase excessively and may be 30 mg KOH/g or less, 20 mg KOH/g or less, 10 mg KOH/g or less, or 5 mg KOH/g or less. The lower limit of the acid value of the fixing resin particles is, but not limited to, 0 mg KOH/g. The acid value is measured by neutralization titration.

The molecular weight of the fixing resin may be 10000 or more. The fixing resin may be nonionic or anionic. In some embodiments, nonionic fixing resins are used. In this instance, the nonionic fixing resin may have an acid value of 10.0 mg KOH/g or less, for example, 5.0 mg KOH/g or less.

Anionic resins may be used as the fixing resin. The acid value of the anionic fixing resin may be 50.0 mg KOH/g or less, 20.0 mg KOH/g or less, 10.0 mg KOH/g or less, or 5.0 mg KOH/g or less.

The fixing resin may be selected from polyurethane resins and acrylic resins. Polyurethane or acrylic fixing resins can increase the fixability of the white image, increasing the rub resistance.

The fixing resin solid content in the white ink composition may be 0.1% to 30.0%, for example, 0.5% to 20.0% or 1.0% to 15.0%, relative to the total mass of the white ink composition. When the fixing resin content is in such a range, printed white images are satisfactorily resistant to rubbing.

### 1.4. Other Constituents

The white ink composition may further contain other constituents such as an organic solvent, a surfactant, water, a wax, and other additives.

### Organic Solvent

The white ink composition may contain an organic solvent. In some embodiments, the organic solvent is soluble in water. The organic solvent can increase the wettability of the white ink composition on the printing medium and improve the moisture retention of the white ink composition. Also, the organic solvent can function as a penetration agent.

Examples of the organic solvent include esters, alkylene glycol ethers, cyclic esters, nitrogen-containing solvents, and polyhydric alcohols. In some embodiments, the organic solvent may be selected from alkylene glycols, nitrogen-containing solvents, and polyhydric alcohols.

Nitrogen-containing solvents include cyclic amides and acyclic amides. Acyclic amides include alkoxyalkylamides. The white ink composition containing a nitrogen-containing organic solvent exhibits an increased wettability on the printing medium and can form images with a higher rub resistance. The organic solvent may contain a nitrogen-containing solvent, for example, an acyclic amide.

Common cyclic amides include lactams, such as 2-pyrrolidone, 1-methyl-2-pyrrolidone, 1-ethyl-2-pyrrolidone, 1-propyl-2-pyrrolidone, and 1-butyl-2-pyrrolidone. These cyclic amides, particularly 2-pyrrolidone, are beneficial for increasing the solubility of the flocculant and facilitating the formation of the coating of resin particles.

Acyclic amides include alkoxyalkylamides and other alkylamides. Alkylamides other than alkoxyalkylamides are those with no alkoxy groups.

Alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-isopropoxy-N,N-dimethylpropionamide, 3-isopropoxy-N,N-diethylpropionamide, 3-isopropoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

In an embodiment, an alkoxyalkylamide represented by the following general formula (1) may be used:

R¹—O—CH₂CH₂—(C═O)—NR²R³ (1)

In general formula (1), R¹ represents an alkyl group having a carbon number of 1 to 4, and R² and R³ independently represent a methyl group or an ethyl group. The alkyl group having a carbon number of 1 to 4 may be linear or branched, and examples thereof include methyl, ethyl, n-propyl, isopropyl, n-butyl, sec-butyl, isobutyl, and tert-butyl. Compounds represented by formula (1) may be used individually or in combination.

Compound represented by formula (1) can facilitate drying the white ink composition applied onto a poorly absorbent printing medium and enhance the fixability of the white ink composition. In particular, formula (1)-represented compounds can favorably soften or dissolve vinyl chloride resin. Accordingly, the formula (1)-represented compounds can soften or dissolve the surface of the poorly absorbent printing medium containing vinyl chloride resin and help the white ink composition to permeate the printing medium. The white ink composition permeating the poorly absorbent printing medium is likely to be fixed firmly to the printing medium and dry readily at the surface. Thus, the resulting image is likely to have a well-dried surface and to be firmly fixed.

In formula (1), R¹may be the methyl group, which has a carbon number of 1. The normal boiling point of the compound having a methyl group as R¹ is lower than the normal boiling point of the formula (1)-represented compound in which R¹ represents an alkyl group having a carbon number of 2 to 4. Accordingly, the formula (1)-represented compound in which R¹ represents the methyl group facilitates drying the surface of the region onto which the white ink composition is applied (particularly in printing under high-temperature, high-humidity conditions).

The nitrogen-containing solvent content may be, but is not limited to, about 2% to 50%, for example, 4% to 30%, relative to the total mass of the white ink composition. When the nitrogen-containing solvent content is in such a range, the printed image can be firmly fixed and have a satisfactorily dried surface (particularly when printed under high-temperature, high-humidity printing conditions).

Alkylene glycol ethers that can be used as the organic solvent include alkylene glycol monoethers and alkylene glycol diethers, and alkyl ethers are practical. More specifically, examples of such alkylene glycol ethers include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether. In some embodiments, alkylene glycol ethers made up of an alkylene glycol moiety having a carbon number of 2 to 6 and an ether moiety having a carbon number of 1 to 4 may be used.

Alkylene glycol monoethers are superior in image quality to diethers.

Polyhydric alcohols that can be used as the organic solvent include 1,2-alkanediols, such as ethylene glycol, propylene glycol (also known as propane-1,2-diol), 1,2-butanediol, 1,2-pentanediol, 1,2-hexanediol, 1,2-heptanediol, and 1,2-octanediol; and other polyhydric alcohols (polyols), such as diethylene glycol, dipropylene glycol, 1,3-propanediol, 1,3-butanediol (also known as 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin.

Polyhydric alcohols are classified into alkanediols and other polyols. The alkanediol that can be used as the organic solvent in an embodiment is a diol of an alkane having a carbon number of 5 or more. The carbon number of the alkane may be 5 to 15, 6 to 10, or 6 to 8. In some embodiments, 1,2-alkanediol may be selected.

The polyol that can be used as the organic solvent in an embodiment may be a polyol derived from an alkane having a carbon number of 4 or less or an intermolecular condensate produced by condensation between some hydroxy groups of polyol molecules derived from alkanes having carbon numbers of 4 or less. The carbon number of the alkane may be 2 or 3. The number of hydroxy groups in the polyol molecule is 2 or more and may be 5 or less, for example, 3 or less. For the intermolecularly condensed polyol, the number of intermolecular condensations is 2 or more and may be 4 or less or 3 or less. A polyhydric alcohol may be used independently, or two or more polyhydric alcohols may be used in combination.

Alkanediols and polyols function mainly as a penetrating solvent and a moisturizing agent or either. Alkanediols are rather penetrating solvents, and polyols are rather moisturizing agents.

Alkanediols and alkylene glycol ethers are useful penetrating solvents and contribute to producing high-quality images. Alkanediols are more useful. In some embodiments, the organic solvent may contain at least one of alkanediols and alkylene glycol ethers.

Also, organic solvents containing polyols can increase the ejection consistency of the ink composition. In some embodiments, the organic solvent contains a polyol.

Esters that can be used as the organic solvent include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, propylene glycol acetate propionate, propylene glycol acetate butyrate, dipropylene glycol acetate butyrate, and dipropylene glycol acetate propionate.

Cyclic esters include lactones, such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, and ε-decanolactone; and compounds derived from these lactones by substituting an alkyl group having a carbon number of 1 to 4 for the hydrogen of the methylene group adjacent to the carbonyl group of the lactone.

For the white ink composition containing an organic solvent, the organic solvent may be an independent compound or a combination of a plurality of compounds. The total content of the organic solvent may be, for example, 5% to 50%, 10% to 45%, 15% to 40%, or 20% to 40% relative to the total mass of the white ink composition. When the organic solvent content is in such a range, the white ink composition exhibits a good balance between wettability and drying and can easily form high-quality images.

In some embodiments, the white ink composition may contain any of the above-described organic solvents, having a normal boiling point of 160.0° C. to 280.0° C. Images printed with such a white ink composition can dry and fix to the printing medium rapidly. Also, the white ink composition exhibits an increased wettability on the printing medium and can form images with higher rub resistance.

In the white ink composition of an embodiment, the content of polyols having normal boiling points of more than 280.0° C. does not exceed 1.0% by mass. The content of polyols having normal boiling points of more than 280° C. may be, by mass, 5% or less, for example, 3% or less, 1% or less, 0.5% or less, or 0.1% or less. The lower limit of the content of such polyols may be 0% by mass. In the description here, the content of a compound does not exceed X % by mass means that the content of the compound is X % by mass or less, implying that the composition does not contain the compound or contains X % by mass or less of the compound.

Images printed with such a white ink composition can dry quickly. Thus, the white ink composition enables high-speed printing and can adhere firmly to the printing medium. In an embodiment, the content of organic solvents (not limited to polyols) having normal boiling points of more than 280.0° C. may be controlled in the above-mentioned ranges. Exemplary organic solvents having normal boiling points of more than 280° C. include glycerin and polyethylene glycol monomethyl ether.

### Surfactant

The white ink composition may contain a surfactant. The surfactant reduces the surface tension of the white ink composition and increases the wettability on the printing medium. In some embodiments, an acetylene glycol-based surfactant, a silicone surfactant, or a fluorosurfactant may be used.

Examples of the acetylene glycol-based surfactant include, but are not limited to, SURFYNOL series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (all produced by Air Products and Chemicals Inc.); OLFINE series B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (all produced by Nissin Chemical Industry); and ACETYLENOL series E00, E00P, E40, and E100 (all produced by Kawaken Fine Chemical).

The silicone surfactant may be, but is not limited to, a polysiloxane compound. For example, polyether-modified organosiloxane may be used as the polysiloxane compound. The polyether-modified organosiloxane is commercially available, and examples thereof include BYK-306, BYK-307, BYK-333, BYK-341, BYK-345, BYK-346, and BYK-348 (all produced by BYK); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (all produced by Shin-Etsu Chemical); and SILFACE SAG series SAG002, SAG005, SAG503A, and SAG008 (all produced by Nissin Chemical Industry).

The fluorosurfactant may be a fluorine-modified polymer, and examples thereof include BYK-3440 (produced by BYK), SURFLON series S-241, S-242, and S-243 (all produced by AGC Seimi Chemical), and FTERGENT 215M (produced by Neos).

The white ink composition may contain a plurality of surfactants. The content of the surfactant, if added, may be 0.1% to 2%, for example, 0.4% to 1.5% or 0.5% to 1.0%, relative to the total mass of the white ink composition.

### Water

The white ink composition disclosed herein may contain water. In some embodiments, the white ink composition is aqueous. “Aqueous” in relation to a composition denotes a composition containing water as one of the major solvents. Using aqueous ink compositions reduces environmental load and enables printing with less odor.

Water may be one of the major solvents in the white ink composition and is a constituent that will be evaporated by drying. Beneficially, the water is pure water or ultra-pure water from which ionic impurities have been removed as much as possible, such as ion-exchanged water, ultrafiltered water, reverse osmosis water, or distilled water. Sterile water prepared by, for example, UV irradiation or addition of hydrogen peroxide may be used. Sterile water can reduce the occurrence of mold or bacteria, and the use thereof is advantageous for storing ink for a long time. The water content in the white ink composition may be 45% or more, for example, 50% to 98% or 55% to 95%, relative to the total mass of the white ink composition.

### Wax

The white ink composition may contain a wax. The wax imparts gloss and smoothness to images printed with the white ink composition, reducing image peeling.

Examples of the wax include vegetable or animal waxes, such as carnauba wax, candelilla wax, beeswax, rice wax, and lanolin; petrolatum waxes, such as paraffin wax, microcrystalline wax, polyethylene wax, oxidized polyethylene wax, and petrolatum; mineral waxes, such as montan wax and ozokerite; synthetic waxes, such as carbon wax, Hoechst wax, polyolefin wax, and stearic acid amide; natural or synthetic wax emulsions, such as a-olefin-maleic anhydride copolymer; and blended waxes. Such waxes may be used individually or in combination. In some embodiments, polyolefin waxes (particularly polyethylene or polypropylene waxes) or paraffin waxes may be used. These waxes are favorable in terms of increasing the fixability of the ink composition to flexible packaging films.

Commercially available waxes may be used as they are, and examples thereof include NOPCOTE PEM-17 (produced by San Nopco), CHEMIPEARL W4005 (produced by Mitsui Chemicals), and AQUACER series 515, 539, and 593 (all produced by BYK).

In an embodiment in which the printing method includes heating, waxes having melting points of 50° C. to 200° C., for example, 70° C. to 180° C. or 90° C. to 150° C. may be used from the viewpoint of preventing the wax from melting and losing the function.

The wax may be in the form of emulsion or suspension. The wax solid content may be 0.1% to 10%, for example, 0.5% to 5% or 0.5% to 2%, relative to the total mass of the white ink composition. When the wax content is in such a range, the wax can function appropriately as intended. When at least either the white ink composition or non-white ink compositions described later herein contains a wax, the final printed image can be satisfactorily glossy and smooth.

### Additives

The white ink composition may contain a urea compound, an amine, a saccharide, or the like as an additive. Examples of the urea compound include urea, ethyleneurea, tetramethylurea, thiourea, 1,3-dimethyl-2-imidazolidinone, and betaines, such as trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, and acetylcarnitine.

Examples of the amine include diethanolamine, triethanolamine, and triisopropanolamine. The urea compound or the amine may be added as a pH adjuster.

Examples of the saccharide include glucose, mannose, fructose, ribose, xylose, arabinose, galactose, aldonic acid, glucitol (sorbitol), maltose, cellobiose, lactose, sucrose, trehalose, and maltotriose.

### Other Additives

The white ink composition disclosed herein may further contain other additives, such as a preservative/fungicide agent, a rust preventive, a chelating agent, a viscosity modifier, an antioxidant, and a fungicide, if necessary.

The surface tension at 25° C. of the white ink composition may be 40 mN/m or less from the viewpoint of appropriately spreading to wet the printing medium. In some embodiments, it may be 38 mN/m or less, for example, 35 mN/m or less or 30 mN/m or less. The surface tension can be determined by measuring the composition wetting a platinum plate at 25° C. with an automatic surface tensiometer CBVP-Z (manufactured by Kyowa Interface Science).

### 1.5 Printing Medium

The white ink composition is used for printing poorly absorbent or non-absorbent printing media. Poorly absorbent or non-absorbent printing media mentioned herein refer to printing media that hardly absorb or do not absorb ink. More specifically, poorly absorbent or non-absorbent printing media exhibit water absorption of 10 mL/m² or less for a period of 30 ms^{1/2} from the beginning of contact with water, measured by the Bristow method. The Bristow method is broadly used for measuring liquid absorption in a short time, and Japan Technical Association of the Pulp and Paper Industry (JAPAN TAPPI) officially adopts this method. Details of this method are specified in Standard No. 51 (Paper and Paperboard-Liquid Absorption Test Method-Bristow's Method (in Japanese)) of JAPAN TAPPI Paper and Pulp Test Methods edited in 2000 (in Japanese). Such a non-absorbent printing medium may be a medium not provided with an ink-absorbent ink-receiving layer at the printing surface thereof or a medium coated with a poorly ink-absorbent layer at the printing surface thereof.

For example, the non-absorbent printing medium may be, but is not limited to, a plastic film not provided with an ink-absorbent layer, or a paper sheet or any other base material coated with or bonded to a plastic film. The term plastic mentioned here may be polyvinyl chloride, polyethylene terephthalate, polycarbonate, polystyrene, polyurethane, or polyolefin. Polyolefin includes polyethylene and polypropylene.

Polyester may be a polyethylene terephthalate.

Printing media of polyolefin or polyester resin films allow the white ink composition to form well-filled images. Printing media of such resin films are likely to reduce the resistance of printed images to lamination and rubbing. The white ink composition disclosed herein is useful in printing such media, particularly polyolefin films.

The poorly absorbent printing medium may be, but is not limited to, coated paper including a coating layer at the surface thereof for receiving oil-based ink. The coated paper may be, but is not limited to, book-printing paper, such as art paper, coat paper, or matte paper.

The white ink composition disclosed herein can be favorably applied onto such non-absorbent or poorly absorbent printing media and quickly form desired images or coatings with high fixability and high rub resistance. Also, poorly absorbent or non-absorbent printing media do not readily absorb ink solvent and cause an amount of solvent to remain on the printing medium, resulting in degraded fastness in terms of the rub resistance and fixability of the printed image. The white ink composition disclosed herein, however, can form printed items with high fastness.

### 1.6. Advantages

The white ink composition disclosed herein contains a nonionic dispersant. The nonionic dispersant is less likely to be affected by the flocculant in the treatment liquid. Accordingly, when the treatment liquid is applied onto a poorly absorbent or non-absorbent printing medium, a well-filled white image can be formed by applying the white ink composition. Also, using a fixing resin that is nonionic or has an acid value of 10.0 mg KOH/g or less helps form more well-filled white images because such a fixing resin is less likely to be affected by the flocculant.

In an embodiment, the white ink composition may be used as one ink of an ink set including the white ink composition and one or more non-white ink compositions described later herein. In an embodiment, the white ink composition may be used as one ink of an ink set including the white ink composition and a treatment liquid described later herein. In an embodiment, the white ink composition may be used as one ink of an ink set including the white ink composition, one or more non-white ink compositions described later, and a treatment liquid described later.

### 2. Printing Method

The printing method disclosed herein includes a white ink application step of applying the above-described white ink composition onto a printing medium by an ink jet method, and a treatment liquid application step of applying a treatment liquid onto the printing medium.

### 2.1. White Ink Application Step

The white ink composition may be applied in any manner provided that the composition is applied while a printing head scans the printing medium. For example, an ink jet head may be used as the printing head to eject the white ink composition. Such ink jet ink application enables effective low-volume high-variety printing with a small device.

The white ink composition is applied onto the printing medium by an ink jet method. Accordingly, the viscosity at 20° C. of the white ink composition may be adjusted to 1.5 mPa·s to 15 mPa·s, for example, 1.5 mPa·s to 7 mPa·s or 1.5 mPa·s to 5.5 mPa·s. The ink jet method enables the white ink composition with such a viscosity to efficiently form desired images on printing media.

An ink jet printing apparatus can facilitate the white ink application step. Details of the ink jet printing apparatus will be described later herein.

### 2.2. Treatment Liquid Application Step

In the treatment liquid application step, a treatment liquid is applied onto the printing medium.

### 2.2.1. Treatment Liquid

The treatment liquid contains a flocculant.

### Flocculant

The treatment liquid contains a flocculant capable of flocculating one or more constituents of non-white ink compositions. The above-described white ink composition is less likely to be flocculated by the flocculant of the treatment liquid and, therefore, can form well-filled images.

The flocculant reacts with the pigment and resin particles in the non-white ink compositions to flocculate the pigment and resin particles. The degree of flocculation of the pigment and resin particles depends on the flocculant, the pigment, and the resin particles and can be adjusted by appropriately selecting these constituents. Also, the flocculant reacts with the pigment and resin particles in the non-white ink compositions to flocculate the pigment and resin particles, as described above. The flocculant increases at least either the color development of pigments or the fixability of resin particles.

The flocculant may be, but is not limited to, a metal salt, an acid, or a cationic compound. The cationic compound may be a cationic resin (cationic polymer) or a cationic surfactant. In some embodiments, a multivalent metal salt may be used as the metal salt flocculant, or a cationic resin may be used as the cationic compound. The acid may be an organic or inorganic acid. Organic acids are more useful. In some embodiments, the flocculant may be selected from among cationic resins, organic acids, and multivalent metal salts from the viewpoint of producing high-quality images with satisfactory rub resistance and gloss.

Multivalent metal salts are beneficial as the flocculant, but other metal salts may be used. In an embodiment, the flocculant may be at least one selected from the group consisting of metal salts and organic acids because these compounds are highly reactive with ink constituents. In an embodiment using a cationic compound, a cationic resin may be selected. Cationic resins are likely to be soluble in the treatment liquid. A plurality of flocculants may be used in combination.

Multivalent metal salts are made up of divalent or higher-valent metal ions and anions. Common divalent or higher-valent metal ions include calcium ion, magnesium ion, copper ion, nickel ion, zinc ion, barium ion, aluminum ion, titanium ion, strontium ion, chromium ion, cobalt ion, and ferrous ion. In some embodiments, at least either the calcium ion or the magnesium ion may be selected as the metal ion of the multivalent metal salt. Calcium and magnesium ions are beneficial for flocculating ink constituents.

The counter anion of the multivalent metal salt may be an inorganic anion or an organic anion. Hence, the multivalent metal salt used in the treatment liquid is a salt made up of an inorganic or organic anion and a multivalent metal ion. Examples of the inorganic anion include chloride ion, bromide ion, iodide ion, nitrate ion, sulfate ion, and hydroxide ion. Examples of the organic anion include organic acid ions, such as carboxylate ions.

The multivalent metal compound may be a multivalent ionic metal salt. In particular, magnesium salts and calcium salts can stabilize the treatment liquid. Also, the counter ion of the multivalent metal ion may be either an inorganic acid ion or an organic acid ion.

Examples of the multivalent metal salt include calcium carbonate including heavy calcium carbonate and light calcium carbonate, calcium nitrate, calcium chloride, calcium sulfate, magnesium sulfate, calcium hydroxide, magnesium chloride, magnesium carbonate, barium sulfate, barium chloride, zinc carbonate, zinc sulfide, aluminum silicate, calcium silicate, magnesium silicate, copper nitrate, calcium acetate, magnesium acetate, and aluminum acetate. Such multivalent metal salts may be used individually or in combination. In some embodiments, at least one salt of magnesium sulfate, calcium nitrate, and calcium chloride may be used, and calcium nitrate is more beneficial. These metal salts are sufficiently soluble in water, and the use thereof tends to reduce traces of the treatment liquid (to make traces less visible). The raw material of the metal salt may contain hydrated water.

In an embodiment, a monovalent metal salt, such as a sodium salt or a potassium salt, may be used as an alternative to the multivalent metal salt, and examples of such a monovalent metal salt include sodium sulfate and potassium sulfate.

Common organic acids include poly(meth)acrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furancarboxylic acid, pyridinecarboxylic acid, coumaric acid, thiophenecarboxylic acid, nicotinic acid, and derivatives or salts of these acids. Such organic acids may be used individually or in combination. Metal salts of organic acids belong to the above-described group of metal salts. The same applies to inorganic acid salts.

Common inorganic acids include sulfuric acid, hydrochloric acid, nitric acid, and phosphoric acid. Such inorganic acids may be used individually or in combination.

Examples of the cationic resin (cationic polymer) include cationic urethane resin, cationic olefin resin, cationic amine resin, and cationic surfactants. The cationic polymer may be soluble in water.

A commercially available cationic urethane resin may be used, and examples thereof include HYDRAN series CP-7010, CP-7020, CP-7030, CP-7040, CP-7050, CP-7060, and CP-7610 (all produced by DIC); SUPERFLEX series 600, 610, 620, 630, 640, and 650 (all produced by DKS); and Urethane Emulsions WBR-2120C and WBR-2122C (both produced by Taisei Fine Chemical).

Cationic olefin resin has a skeleton containing an olefin, such as ethylene or propylene. Any known olefin resin may be used as required. The cationic olefin resin may be dispersed in a liquid medium, such as water or an organic solvent, thus being in the form of an emulsion. A commercially available cationic olefin resin may be used, and examples thereof include ARROWBASE series CB-1200 and CD-1200 (both produced by Unitika).

The cationic amine resin (cationic amine polymer) is not particularly limited provided that it has an amino group in the molecule and may be selected from among known cationic amines. For example, the cationic amine resin may be polyamine resin, polyamide resin, or polyallylamine resin. Polyamine resin has amino groups on the backbone of the resin. Polyamide resin has amide groups on the backbone of the resin. Polyallylamine resin has a structure derived from the allyl group on the backbone of the resin.

Examples of the cationic polyamine resin include UNISENCE KHE 103L (aqueous solution of hexamethylenediamine-epichlorohydrin resin with a solid content of 50% by mass, 1% aqueous solution thereof has a pH of about 5.0 and a viscosity of 20 mPa·s to 50 mPa·s) and UNISENCE KHE104L (aqueous solution of dimethylamine-epichlorohydrin resin with a solid content of 20% by mass, 1% aqueous solution thereof has a pH of about 7.0 and a viscosity of 1 mPa·s to 10 mPa·s), both produced by SENKA Corporation. Other cationic polyamine resins are also commercially available, and examples thereof include FL-14 (produced by SNF), ARAFIX series 100, 251S, 255, and 255LOX (all produced by Arakawa Chemicals), DK-6810, DK-6853, DK-6885, WS-4010, WS-4011, WS-4020, WS-4024, WS-4027, and WS-4030 (all produced by Seiko PMC Corporation), PAPYOGEN P-105 (produced by SENKA Corporation), SUMIREZ Resins 650(30), 675A, 6615, and SLX-1 (all produced by Taoka Chemical), CATIOMASTER (registered trademark) series PD-1, PD-7, PD-30, A, PDT-2, PE-10, PE-30, DT-EH, EPA-SK01, and TMHMDA-E (all produced by Yokkaichi Chemical), and JETFIX series 36N, 38A, and 5052(all produced by Satoda Chemical Industrial).

Examples of the polyallylamine resin include polyallylamine hydrochloride, polyallylamine amidosulfate, allylamine hydrochloride-diallylamine hydrochloride copolymer, allylamine acetate-diallylamine acetate copolymer, allylamine hydrochloride-dimethylallylamine hydrochloride copolymer, allylamine-dimethylallylamine copolymer, polydiallylamine hydrochloride, polymethyldiallylamine hydrochloride, polymethyldiallylamine amidosulfate, polymethyldiallylamine acetate, polydiallyldimethylammonium chloride, diallylamine acetate-sulfur dioxide copolymer, diallylmethylethylammonium ethylsulfate-sulfur dioxide copolymer, methyldiallylamine hydrochloride-sulfur dioxide copolymer, diallyldimethylammonium chloride-sulfur dioxide copolymer, and diallyldimethylammonium chloride-acrylamide copolymer.

Examples of the cationic surfactant used as the flocculant include primary, secondary, and tertiary amine salts including alkyl amine salts, dialkyl amine salts, and aliphatic amine salts; quaternary ammonium salts, such as benzalkonium salts and other quaternary alkyl ammonium salts; and alkyl pyridinium salts, sulfonium salts, phosphonium salts, onium salts, and imidazolinium salts. More specifically, examples of such a cationic surfactant include hydrochlorides or acetates of laurylamine, palm amine, and rosin amine, lauryltrimethylammonium chloride, cetyltrimethylammonium chloride, benzyltributylammonium chloride, benzalkonium chloride, dimethylethyllaurylammonium ethyl sulfate, dimethylethyloctylammonium ethyl sulfate, trimethyllaurylammonium hydrochloride, cetylpyridinium chloride, cetylpyridinium bromide, dihydroxyethyllaurylamine, decyldimethylbenzylammonium chloride, dodecyldimethylbenzylammonium chloride, tetradecyldimethylammonium chloride, hexadecyldimethylammonium chloride, and octadecyldimethylammonium chloride.

A plurality of flocculants may be used in combination. Also, by selecting at least one of a multivalent metal salt, an organic acid, and a cationic resin from among the flocculants cited above, the treatment liquid can exhibit an appropriate flocculating function, thus helping to form high-quality images (particularly in terms of color development).

The flocculant content in the treatment liquid may be 0.1% to 20%, for example, 1% to 20% or 2% to 15%, relative to the total mass of the treatment liquid. For using a flocculant in the form of a solution or a dispersion, it is beneficial to control the flocculant solid content in such a range. When the flocculant content is 1% by mass or more, the flocculant can sufficiently flocculate ink constituents. In addition, when the flocculant content is 30% by mass or less, the flocculant is likely to dissolve or disperse sufficiently in the treatment liquid, increasing the storage stability of the treatment liquid.

The solubility of the flocculant in 100 g of water at 25° C. may be 1 g or more, for example, 3 g to 80 g. Such a flocculant can be soluble in the treatment liquid even if the treatment liquid contains a hydrophobic organic solvent.

### Other Constituents

The treatment liquid may further contain resin particles, a water-soluble organic solvent, a surfactant, water, a wax, a resin dispersant, a preservative/fungicide agent, a rust preventive, a chelating agent, a viscosity modifier, an antioxidant, a fungicide, and other additives in addition to the flocculant. These constituents are the same as those described for the white ink composition, and thus description thereof is omitted. In some embodiments, the treatment liquid is aqueous.

### 2.2.2. Physical Properties and Application to Printing Medium of Treatment Liquid

The surface tension at 25° C. of the treatment liquid used in the printing method disclosed herein may be 40 mN/m or less, 38 mN/m or less, 35 mN/m or less, or 30 mN/m or less from the viewpoint of appropriately spreading to wet the printing medium. The surface tension can be determined by measuring the composition wetting a platinum plate at 25° C. with an automatic surface tensiometer CBVP-Z (manufactured by Kyowa Interface Science).

The treatment liquid may be applied by an ink jet method, painting, or spraying. Alternatively, the printing medium may be soaked with the treatment liquid or painted with a brush or the like. Thus, the treatment liquid may be applied onto the printing medium in a contacting manner or a non-contacting manner, or by a combination thereof.

In some embodiments, the treatment liquid may be applied onto the printing medium by an ink jet method. In this instance, the viscosity of the treatment liquid at 20° C. may be controlled to 1.5 mPa·s to 15 mPa·s, for example, 1.5 mPa·s to 7 mPa·s or 1.5 mPa·s to 5.5 mPa·s. The ink jet method facilitates efficient application of the treatment liquid onto a predetermined region of the printing medium.

### 2.3. Advantages

The white ink composition used in the printing method disclosed herein contains a nonionic dispersant. The nonionic dispersant is less likely to be affected by the flocculant in the treatment liquid. Accordingly, even though poorly absorbent or non-absorbent printing media are printed by the printing method, well-filled white images can be formed.

### 2.4. Other Steps

In an embodiment, the printing method may include other steps, such as a non-white ink application step, a heating step, and a lamination step, in addition to the above-described white ink application and treatment liquid application steps.

### 2.4.1. Non-White Ink Application Step

In the non-white ink application step, a non-white ink composition is applied onto the printing medium in the same manner as the white ink composition.

### 2.4.1.1. Non-White Ink Composition

The non-white ink composition contains a non-white pigment.

### Non-White Pigment

The non-white pigment contained in the non-white ink composition refers to a coloring material other than the white pigment described above. The non-white pigment may be a coloring material for cyan, yellow, magenta, black, etc.

The non-white pigment is desirably resistant to light, weather, gases, and the like and is thus stable in storage. In some embodiments, organic pigments are selected from this viewpoint.

Examples of the non-white pigment include azo pigments such as insoluble azo pigments, condensed azo pigments, azo lake, and chelate azo pigments; polycyclic pigments such as phthalocyanine pigments, perylene and perinone pigments, anthraquinone pigments, quinacridone pigments, dioxane pigments, thioindigo pigments, isoindolinone pigments, and quinophthalone pigments; and dye chelates, dye lakes, nitro pigments, nitroso pigments, aniline black, daylight fluorescent pigments, and carbon black. Such pigments may be used individually or in combination. A glittering pigment may be used as the non-white pigment.

More specific examples will be cited below, but the non-white pigment is not limited to the following examples.

Examples of black pigments include No. 2300, No. 900, MCF88, No. 33, No. 40, No. 45, No. 52, MA7, MA8, MA100, and No. 2200B (all produced by Mitsubishi Chemical Corporation); Raven 5750, Raven 5250, Raven 5000, Raven 3500, Raven 1255, and Raven 700 (all produced by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all produced by Cabot); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (all produced by Degussa).

Examples of yellow pigments include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of magenta pigments include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violets 19, 23, 32, 33, 36, 38, 43, and 50.

Examples of cyan pigments include C.I. Pigment Blues 1, 2, 3, 15, 15:1, 15:2, 15:3, 15:34, 15:4, 16, 18, 22, 25, 60, 65, and 66; and C.I. Vat Blues 4 and 60.

Pigments other than magenta, cyan, and yellow pigments include, but are not limited to, C.I. Pigment Greens 7 and 10, C.I. Pigment Browns 3, 5, 25, and 26, and C.I. Pigment Oranges 1, 2, 5, 7, 13, 14, 15, 16, 24, 34, 36, 38, 40, 43, and 63.

Pearl pigments may also be used as the non-white pigment, and examples thereof include, but are not limited to, pigments exhibiting pearly gloss or interference gloss, such as titanium dioxide-coated mica, fish scale foil, and bismuth oxychloride.

Metallic pigments may also be used as the non-white pigment, and examples thereof include, but are not limited to, elemental metals, such as aluminum, silver, gold, platinum, nickel, chromium, tin, zinc, indium, titanium, and copper, and alloys such elemental metals.

In some embodiments, the non-white pigment is dispersible or soluble in water. For a stable pigment dispersion, a dispersant may be used as needed. The dispersant may be the same as the dispersant used in the white ink composition for increasing the dispersibility of the white pigment. Also, other dispersants subject to the influence of the flocculant of the treatment liquid may be used.

Such a dispersant is non-nonionic, that is, anionic or cationic. In some embodiments, anionic dispersants are used. Non-nonionic dispersants are apart from the above-described nonionic dispersants. Examples of the non-nonionic dispersants include (meth)acrylic resins and salts thereof, such as poly(meth)acrylic acids, (meth)acrylic acid-acrylonitrile copolymers, vinyl acetate-(meth)acrylic acid copolymers, and vinyl naphthalene-(meth)acrylic acid copolymers; styrene resin and salts thereof, such as styrene-(meth)acrylic acid copolymers, styrene-(meth)acrylic acid-(meth)acrylic ester copolymers, styrene-α-methylstyrene-(meth)acrylic acid copolymers, styrene-α-methylstyrene-(meth)acrylic acid-(meth)acrylic ester copolymers, styrene-maleic acid copolymers, and styrene-maleic anhydride copolymers; urethane resins and salts thereof that are linear or branched polymers having urethane bonds formed by a reaction of isocyanate groups and hydroxy groups and having or not having crosslinked structures; polyvinyl alcohols; vinyl naphthalene-maleic acid copolymers and salts thereof; vinyl acetate-maleic ester copolymers and salts thereof; and vinyl acetate-crotonic acid copolymers and salts thereof; and other water-soluble resins. In some embodiments, the non-nonionic dispersant is a copolymer of monomers having hydrophobic functional groups and monomers having hydrophilic functional groups, or a polymer formed of monomers having both hydrophobic and hydrophilic functional groups. Such a copolymer may be a random copolymer, a block copolymer, an alternating copolymer, or a graft copolymer.

The non-white pigment content in the non-white ink composition may be 0.3% to 20%, for example, 0.5% to 15%, relative to the total mass of the non-white ink composition. In some embodiments, the non-white pigment content is, by mass, 1% to 8% or 2% to 6%. The non-white pigment may be flocculable or poorly flocculable. From the viewpoint of reducing bleeding, a flocculable pigment may be used.

The volume average particle size of the non-white pigment (before being mixed with the treatment liquid) may be 10 nm to 300 nm, for example, 30 nm to 250 nm, 50 nm to 250 nm, or 70 nm to 200 nm. The volume average particle size of the non-white pigment is the value in the initial state of the pigment measured by the method described above. Non-white pigments having such volume average particle sizes are easily available and whose properties can be easily adjusted as desired.

### Other Constituents

The non-white ink composition may further contain a fixing resin, a water-soluble organic solvent, a surfactant, water, a wax, a resin dispersant, a preservative/fungicide agent, a rust preventive, a chelating agent, a viscosity modifier, an antioxidant, a fungicide, and other additives in addition to the non-white pigment.

These constituents are the same as those described for the white ink composition, provided that the white ink composition in the description is replaced with the non-white ink composition, and thus description thereof is omitted.

### 2.4.1.2. Physical Properties and Application to Printing Medium of Non-White Ink Composition

When the non-white ink composition mixes with the treatment liquid, one or more constituents of the ink composition are flocculated by the effect of the flocculant, unlike the white ink composition. Also, when mixing with the treatment liquid, the viscosity of the non-white ink composition increases.

The non-white ink composition is applied onto the printing medium by an ink jet method. For this application, the viscosity at 20° C. of the non-white ink composition may be adjusted to 1.5 mPa·s to 15 mPa·s, for example, 1.5 mPa·s to 7 mPa·s or 1.5 mPa·s to 5.5 mPa·s. The ink jet method facilitates efficient formation of desired images on the printing medium with the non-white ink composition.

In an embodiment of the printing method, the surface tension at 25° C. of the non-white ink composition is 40 mN/m or less, for example, 38 mN/m or less, 35 mN/m or less, or 30 mN/m or less, from the viewpoint of appropriately spreading to wet the printing medium. The surface tension of the non-white ink composition is measured in the same manner as that of the white ink composition.

In an embodiment of the printing method including the non-white ink application step, the white and non-white ink compositions are applied one on top of the other. Thus, the white image layer formed with the white ink composition acts as the undercoat layer of the non-white image formed with the non-white ink composition to hide the background of the final printed image. Since the white image layer is satisfactorily filled, as described above, the final printed image can be highly visible.

In an embodiment of the printing method including the non-white ink application step, the non-white ink composition is applied onto the printing medium to form a non-white ink composition layer, and the white ink composition is applied onto the non-white ink composition layer to form a white ink composition layer over the non-white ink composition layer. The final printed image thus formed can be highly visible when viewed from the opposite side to the printed side of the printing medium onto which the white ink and non-white ink compositions have been applied. In addition, since the white image layer is satisfactorily filled, as described above, the printed image can be more highly visible.

### 2.4.2. Heating Step

### Primary Heating Step

In an embodiment of the printing method disclosed herein, the white ink and non-white ink application steps include respective heating steps of heating the ink composition on the printing medium. Such a heating step is referred to as a primary heating step. The primary heating step rapidly heats and dries the ink composition applied onto the printing medium. In this heating step, the ink composition is applied onto a heated printing medium or heated immediately after being applied onto a printing medium, for example, within about 1 s after the application. In an embodiment, the printing medium may be further heated before or after any of the treatment liquid and ink application steps. Heating may be performed with a drying device using a heating mechanism. The drying device may be a blowing type operable to blow the printing medium with ambient air or warm air, a radiation type operable to irradiate the printing medium with heat-generating radiation, such as infrared radiation, or a conduction type operable to conduct heat to the printing medium in contact with the drying device. Such drying devices may be used individually or in combination. In an embodiment, a radiation-type drying device may be used. The drying device using a heating mechanism can quickly dry the ink composition applied onto the printing medium.

The heating mechanism may be located immediately before or after each composition is applied. The heating from such a position reduces the heat applied to the ink jet head, reducing clogging. Thus, increased ejection consistency can be expected.

The surface temperature of the printing medium in the ink and treatment liquid application steps may be 45.0° C. or less, for example, 43.0° C. or less, 40.0° C. or less, 38.0° C. or less, 35.0° C. or less, 32.0° C. or less, 30.0° C. or less, or 28.0° C. or less. The lower limit may be 20.0° C. or more, for example, 23.0° C., 25.0° C., 28.0° C., 30.0° C., or 32.0° C.

The printing medium surface temperature in each application step is the temperature of the portion of the printing medium that has received the ink composition or treatment liquid and is the highest temperature at the portion in the application step. A lower surface temperature than the above ranges is beneficial in terms of reducing clogging and increasing gloss. In contrast, a higher surface temperature than the above ranges is beneficial in terms of increasing image durability and spreading the ink compositions on the printing medium to improve image quality.

The printing medium surface temperature in the ink and treatment liquid applications may be set relatively high by heating with a heating mechanism or kept relatively low by omitting the heating.

Heating may be performed simultaneously with one or more application steps. For simultaneous heating with the application steps, the printing medium surface temperature may be controlled to 43.0° C. or less, for example, 40.0° C. or less. Such simultaneous heating may be referred to as primary heating.

### Post-Application Heating Step

In an embodiment, the printing method may further include a post-application heating step of heating the printing medium after the treatment liquid and ink application steps and the respective primary heating steps. The post-application heating step may be referred to as a secondary heating step. In the post-application heating step, heating starts more than 1 s after receiving the compositions.

For the post-application heating, a heating device may be used, if necessary. For example, the post-application heating step uses an after-heater (corresponding to the secondary heater 5 in the ink jet printing apparatus 1 described later herein). Any appropriate heating device may be used without limitation to the heating devices provided for the ink jet printing apparatus. Such post-application heating promotes drying and sufficiently fixes the printed image. Consequently, for example, the resulting printed item can be used immediately after printing.

In the post-application heating step, the temperature of the printing medium is not particularly limited but may be set in view of, for example, the glass transition temperature (Tg) of the resin particles in the printed image. When the Tg of the resin particles or the wax should be taken into account, the temperature of the printing medium may be set to higher than the Tg of the polymer components by 5.0° C. or more, for example, by 10.0° C. or more.

The post-application heating increases the printing medium surface temperature to 30.0° C. to 120.0° C., for example, 40.0° C. to 100.0° C., 50.0° C. to 95° C., or 70° C. to 90° C. In some embodiments, the printing medium surface may be heated to 80° C. or more by the post-application heating. When the printing medium is heated to such a temperature, the resin particles in the printed image can form a coating film to flatten the surface of the printed image, and the printed image can be more sufficiently dried and fixed.

### 2.4.3. Lamination Step

The printed side of the printed item produced by the printing method may be subjected to lamination before use. In the lamination step, the printed side of the printing medium that has received the treatment liquid and ink compositions is laminated by, for example, bonding a film to the printed side. In this instance, the film and the printed side of the printed item may be bonded together using a known adhesive applied to either the printed side or the film. Alternatively, a melted resin may be extruded onto the printed side of the printed item to form a film over the printed side. The film used for the lamination may be a resin film. Laminating the printed items increases the rub resistance of the printed items, thus protecting the printed items from impact with a hard solid object or any other severe handling. In some embodiments, the printed item is further heated or pressed at room temperature after the lamination for sufficient adhesion between the printed side and the film.

When a printed item produced by the printing method disclosed herein is laminated, the lamination film of the laminated printed item is difficult to peel. However, the printed medium, having received the treatment liquid and ink compositions, may be used as a printed item without lamination. In an embodiment, the printing method may include the lamination step.

### 2.4.4. Order of Steps and Modifications of the Printing Method

The application order of the white and non-white ink embodiments, the white ink composition is applied after the non-white ink application step. In this instance, the white ink composition forms the background of the non-white image formed on a transparent printing medium, increasing the definition and quality of the final printed image. In the resulting printed item, the non-white image is viewed from the rear side of the transparent printing medium. The visibility on the non-white image side is high.

In an embodiment, a non-white image of the non-white ink compositions may be formed on a white image formed on a printing medium. In this instance, the non-white image of the final printed image is viewed from the front side of the printing medium.

When a white image of the white ink composition is formed on a non-white image on a printing medium, the printed item tends to exhibit low resistance to rubbing and lamination. The concept of the present disclosure is beneficial in such a case.

In some embodiments, the treatment liquid is applied before the white ink and non-white ink application steps. In this instance, the flocculant in the treatment liquid can react sufficiently with the non-white ink composition.

### 2.4.5. Other Steps

The printing method may further include a step of optionally applying at least one of the treatment liquid, the white ink composition, and the non-white ink composition(s) onto the printing medium. In this step, the order and number of these applications are not limited, and the treatment liquid and ink compositions may be applied at any time in any order. In some embodiments, the treatment liquid and the ink compositions are applied to the same area of the printing medium.

### 3. Ink Jet Printing Apparatus

The printing method of an embodiment of the present disclosure may use an ink jet printing apparatus including a printing head. The treatment liquid application step may also be performed by using an ink jet printing apparatus as needed. The ink jet printing apparatus that can be used in the printing method disclosed herein will now be described.

The ink jet printing apparatus includes one or more ink jet heads from which the ink compositions and optionally the treatment liquid are ejected to apply the compositions onto printing media. An ink jet printing apparatus used in an embodiment of the printing method will now be described with reference to the drawings. The dimensional proportions of the members or components in the drawings are varied as needed.

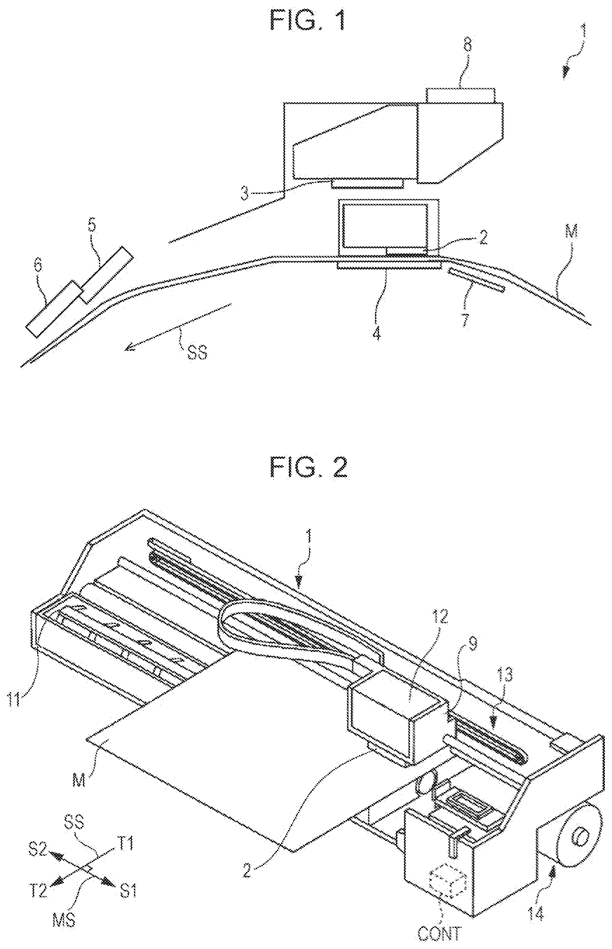

FIG. 1 is a schematic sectional view of an ink jet printing apparatus 1. FIG. 2 is a perspective view illustrating an exemplary configuration of the carriage and its vicinity of the ink jet printing apparatus 1 depicted in FIG. 1. As depicted in FIGS. 1 and 2, the ink jet printing apparatus 1 includes an ink jet head 2, an IR heater 3, a platen heater 4, a secondary heater 5, a cooling fan 6, a preheater 7, a blowing fan 8, a carriage 9, a platen 11, a carriage transfer mechanism 13, a medium transport device 14, and a control unit CONT. The general operation of the ink jet printing apparatus 1 is controlled by the control unit CONT depicted in FIG. 2.

The ink jet head 2 is configured to eject the treatment liquid and ink compositions through nozzles, thus applying the treatment liquid and ink compositions onto a printing medium M. In the following description, the expression “ink compositions” refers to at least one of the white ink and non-white ink compositions.

The ink jet head 2 illustrated in FIG. 2 is of a serial type that applies ink compositions onto the printing medium M while moving across the printing medium M in main scanning directions a plurality of times. The ink jet head 2 is mounted on or in the carriage 9 depicted in FIG. 2. The ink jet head 2 passes across the printing medium M in the main scanning directions a plurality of times associated with the operation of the carriage transfer mechanism 13 that transfers the carriage 9 in the width directions of the printing medium M. The width directions of the printing medium are the main scanning directions in which the ink jet head 2 scans the printing medium M. A plurality of passes of the printing head 2 in the main scanning directions is referred to as the main scan.

In the illustrated embodiment, the main scanning directions are directions in which the carriage 9 equipped with the ink jet head 2 moves. In FIG. 1, the main scanning directions intersect the sub-scanning direction indicated by arrow SS, which is the direction in which the printing medium M is transported or fed. In FIG. 2, the width directions of the printing medium M, that is, the S1-S2 directions, are the main scanning directions MS, and the T1→T2 direction is the sub-scanning direction SS. A pass implies that the ink jet head 2 moves across the printing medium in either direction indicated by arrow S1 or S2. By repeating the pass across the printing head 2 and the transport of the printing medium M in the sub-scanning direction, the printing medium M is printed. In other words, the treatment liquid and the ink compositions are applied by a plurality of passes of the ink jet head 2 moving in the main scanning directions and a plurality of movements of the printing medium M fed in the sub-scanning direction intersecting the main scanning directions.

A cartridge set 12 includes a plurality of cartridges independent of each other that feed respective ink compositions to the ink jet head 2. The cartridge set 12 is removably mounted on or in the cartridge 9 equipped with the ink jet head 2. The plurality of cartridges contains respective compositions, such as the treatment liquid, the ink compositions, and optional compositions. Each composition is fed to the nozzles from the corresponding cartridge (cartridge set 12). Although in the illustrated embodiment, the cartridge set 12 is mounted on or in the carriage 9, the cartridge set or cartridges of an embodiment may be disposed at a position other than the carriage 9 so that the ink compositions can be fed to the nozzles through a feed tube (not shown).

The compositions can be ejected from the ink jet head 2 by a known technique. In the illustrated embodiment, the ink jet head 2 ejects droplets in response to vibration of piezoelectric elements, that is, ejects droplets formed by mechanical deformation of electrostrictive elements.

The ink jet printing apparatus 1 may include a heating mechanism operable to heat the printing medium M when compositions are applied onto the printing medium M by being ejected from the ink jet head 2. The heating mechanism may be based on heat conduction, blowing, heat radiation, or the like. The heat conduction type conducts heat to the printing medium M from a member in contact with the printing medium. The platen heater 4 is an example of the heat conduction-type heating mechanism. The blowing type blows normal-temperature or warm air on the printing medium to dry the composition. The blowing fan 8 is an example of the blowing-type heating mechanism. The heat-radiation type radiates heat-generating radiation to dry the printing medium M. The IR heater 3 is an example of the heat-radiation-type heating mechanism. Such heating mechanisms may be used individually or in combination.

For example, the ink jet printing apparatus 1 of the illustrated embodiment includes the IR heater 3, the platen heater 4, and the blowing fan 8 as the heating mechanism. The IR heater 3, the platen heater 4, and the blowing fan 8, and the like can be used for drying the printing medium M in a heating step.

The IR heater 3 is operable to heat the printing medium M by emitting infrared radiation from the side on which the ink jet head 2 is located. The ink jet head 2 tends to be heated simultaneously with the printing medium M. However, the IR heater can efficiently heat the printing medium M without interference of the printing medium thickness, unlike when the platen heater 4 or the like heats the printing medium M from the rear side. The blowing fan 8 can apply warm or ambient air to the printing medium M to dry the compositions on the printing medium M.

The platen heater 4 can heat the printing medium M with the platen 11 therebetween, at a position opposite the ink jet head 2, to dry the compositions ejected from the ink jet head 2 immediately after the compositions have been applied onto the printing medium M. The platen heater 4 may be located downstream or upstream, in the medium M transport direction, from the ink jet head 2. This reduces the likelihood that the platen heater 4 heats the ink jet head 2, consequently reducing clogging or the like. The platen heater 4, which heats the printing medium M by heat conduction, is optionally provided for the printing method. In the embodiments using a platen heater, the surface temperature of the printing medium M may be controlled to 45.0° C. or less, for example, 40.0° C. or less. The platen heater 4 corresponds to an under-heater used in a line ink jet printing apparatus. In the embodiments including no heating steps, the printing apparatus does not necessarily include heating mechanisms.

In the ink application steps, the printing medium M surface may be heated up to 45.0° C. In some embodiments, the upper limit of the printing medium surface temperature may be 40.0° C. or less, for example, 38.0° C. or 35.0° C. Also, the lower limit of the printing medium M surface temperature may be 25.0° C. or more, for example, 28.0° C., 30.0° C., or 32.0° C. Thus, the compositions in the ink jet head 2 can be prevented from drying or altering, thus reducing the likelihood that the compositions or the resins therein melt and adhere to the inner wall of the ink jet head 2. Also, the compositions can be fixed soon to the printing medium M. Thus, controlling the printing medium surface temperature in such a range increases the resistance of the printed image to blocking and lamination, resulting in improved image quality.

In an embodiment of the printing method, a post-application heating step may be conducted to dry and fix the compositions. This step may be referred to as the secondary heating.

The secondary heater 5 used in the post-application heating step dries or solidifies the compositions on the printing medium M, thus acting as an auxiliary heater or dryer. The secondary heater 5 is used for post-application heating. The secondary heater 5 heats images printed on the printing medium M to rapidly evaporate water and other solvents from the compositions, thus helping the resin in the compositions to form an ink film. The ink film is firmly fixed or adheres to the printing medium M, thus forming a high-quality image quickly.

The upper limit of the surface temperature of the printing medium M heated with the secondary heater 5 may be 120.0° C. or less, for example, 100.0° C. or 90.0° C. Also, the lower limit of the surface temperature of the printing medium M at this time may be 60.0° C. or more, for example, 70.0° C. or 80.0° C. By controlling the printing medium surface temperature in such a range, high-quality images can be formed quickly. The secondary heater 5 corresponds to an after-heater used in a line ink jet printing apparatus and may be implemented as a carbon heater or the like.

The illustrated ink jet printing apparatus 1 includes the cooling fan 6. By cooling the compositions on the printing medium M with the cooling fan 6 after drying the compositions applied onto the printing medium M, the coating films of the compositions can adhere firmly to the printing medium M.

The illustrated ink jet printing apparatus 1 also includes the preheater 7 operable to previously heat the printing medium M before the compositions are applied onto the printing medium M. In an embodiment, a line ink jet printing apparatus may be used. The line printer may include a preheater 7 as a heating mechanism.

Below the carriage 9 are disposed the platen 11 on which the printing medium M is supported, the carriage transfer mechanism 13 operable to move the carriage 9 relative to the printing medium M, and the medium transport device 14 that is a roller for transporting the printing medium M in the sub-scanning direction. The control unit CONT controls the operations of the carriage transfer mechanism 13 and the medium transport device 14.

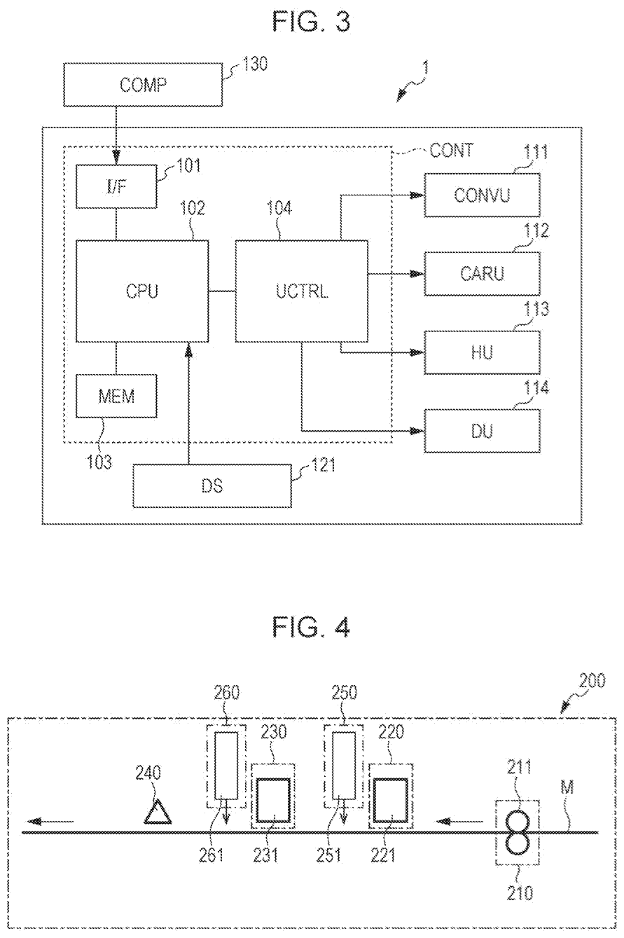

FIG. 3 is a functional block diagram of the ink jet printing apparatus 1. The control unit CONT controls the ink jet printing apparatus 1. An interface (I/F) 101 enables data communication between the computer (COMP) 130 and the ink jet printing apparatus 1. A CPU 102 is an arithmetic processing unit configured to control the general operation of the printing apparatus 1. A memory device (MEM) 103 secures storage in which the program of the CPU 102 is stored and a region in which the CPU 102 works. The CPU 102 causes a unit control circuit (UCTRL) 104 to control various units. Detectors (DS) 121 monitor the interior of the ink jet printing apparatus 1. The control unit CONT controls each unit according to the monitoring results of the detectors.

A transport unit (CONVU) 111 controls the medium transport for ink jet printing, specifically, the direction, distance, and speed for transporting the printing medium. More specifically, the direction, distance, and speed of the printing medium M to be transported are controlled by the direction, amount, and speed of the rotation of the transport roller driven by a motor.

A carriage unit (CARU) 112 controls the main scan (passes) for ink jet printing and reciprocally moves the ink jet head 2 in the main scanning directions. The carriage unit 112 includes the carriage 9 equipped with the printing head 2, and the carriage transfer mechanism 13 operable to reciprocally move the carriage 9.

A head unit (HU) 113 controls the amount of the compositions ejected through the nozzles of the ink jet head 2. For example, in an embodiment in which piezoelectric elements drive the ejection through the nozzles of the ink jet head 2, the head unit 113 controls the operation of the piezoelectric elements. More specifically, the head unit 113 controls the application timing and dot size of each composition. Also, the amounts of compositions applied in each pass are controlled by a combined control of the carriage unit 112 and the head unit 113.

A drying unit (DU) 114 controls the temperatures of heaters, such as the IR heater 3, the preheater 7, the platen heater 4, and the secondary heater 5.

The ink jet printing apparatus 1 alternately repeats the operation of moving the carriage 9 equipped with the ink jet head 2 in a main scanning direction and the operation of transporting the printing medium in the sub-scanning direction. For each pass, the control unit CONT controls the carriage unit 112 to move the ink jet head 2 in a main scanning direction and also controls the head unit 113 to eject the compositions through specific nozzle openings of the ink jet head 2. Droplets of the compositions are thus applied onto the printing medium M. The control unit CONT also controls the transport unit 111 to transport (feed) the printing medium M to a predetermined degree in the medium transport direction.

In the ink jet printing apparatus 1, the region on which a plurality of droplets is deposited is gradually fed by alternately repeating the pass and the medium transport. Then, the droplets on the printing medium M are dried with the after-heater 5 to complete an image. The completed printed item may be then wound into a roll by a winding mechanism or transported by a flatbed mechanism.

The ink jet head 2 may include a circulation mechanism (not shown) to circulate the treatment liquid and the ink compositions. The circulation mechanism can minimize the changes in composition concentration that may occur in the ink jet head 2, contributing to consistent ejection.

Although the illustrated printing apparatus is a serial type including a serial ink jet head, the ink jet head 2 may be a line head. The ink jet head of a line printing apparatus has nozzles in an arrangement with a length more than or equal to the width of the printing medium and can apply ink compositions across the printing medium M by a pass.

FIG. 4 is a schematic sectional diagram of a portion of a line printing apparatus that includes a line printing head (line ink jet head) and is operable for a line printing method. The section designated by numeral 200 of the printing apparatus includes a treatment liquid application unit 220 including an ink jet head 221 for the treatment liquid, an ink application unit 230 including an ink jet head 231 for an ink composition, a printing medium transport unit 210 including rollers 211 to transport the printing medium M, and a post-application heating device 240 for post-application heating. Section 200 also includes a primary heating device 250 including a blower 251 operable for a primary heating after the treatment liquid application step, and another primary heating device 260 including another blower 261 for primary heating after the ink application step. The ink jet heads 231 and 221 are line heads having nozzles in an arrangement extending in the width direction of the printing medium M that is the direction from the front to the back of the figure.

The line printing apparatus applies compositions onto the printing medium M by ejecting the compositions from the ink jet heads 231 and 221 while feeding the printing medium M in the direction indicated by the arrow depicted in FIG. 4 to change the relative position of the printing medium M to the ink jet heads. A series of such behaviors of the printing apparatus is referred to as scan. A motion for the scan is called a pass. The line printing method is a single-pass printing method of printing across the printing medium M fed (transported) by a single pass, using the ink jet heads 231 and 221.

The line printing apparatus may be the same as the above-described serial printing apparatus 1 except for including at least one line ink jet head and performing line printing. In an embodiment, the line printing apparatus may include three or more ink jet heads. The line printing apparatus may include a heating divide for a heating step. For example, a heating device such as the blowing fan 8 or IR heater 3 disposed over the ink jet head 2 in FIG. 1 may be provided over the ink jet heads 231 and 221 in FIG. 4. Also, a heating device such as an under-heater corresponding to the platen heater 4 disposed under the ink jet head 2 in FIG. 1 may be provided under the ink jet heads 231 and 221 in FIG. 4 or downstream or upstream, in the medium transport direction, from the ink jet heads.

The section 200 of the printing apparatus in FIG. 4 also includes a primary heating device 250 including a blower 251 operable for a primary heating after the treatment liquid application step, and another primary heating device 260 including another blower 261 for primary heating after the ink application step, as described above. The section 200 may include three or more sets of application units and primary heating devices according to the number of compositions to be applied to the printing medium. As an alternative to the blowers, under-heaters may be used.

For applying the treatment liquid or the ink compositions by an ink jet method, either a serial or a line printing apparatus may be used. A line printing apparatus enables high-speed printing.

### 4. Examples and Comparative Examples

The subject matter of the present disclosure will be further described in detail with reference to the following Examples and Comparative Examples. However, it is not limited to the Examples, and various modifications may be made unless departing from the scope and spirit of the present disclosure. In the following description, “%” and “part(s)” are on a mass basis unless otherwise specified.

### 4.1. Preparation of Ink Compositions and Treatment Liquids

White ink compositions W1 to W13, non-white ink compositions C1 to C3, and treatment liquids R1 to R3 were prepared using the constituents with respective contents presented in Tables 1, 2, and 3. More specifically, each ink or treatment liquid was prepared by stirring the constituents presented in Tables 1 to 3 in a container with a magnetic stirrer for 2 hours, followed by filtering through a membrane filter of 5 μm in pore size to remove impurities, such as foreign substances and coarse particles. All the values in Tables 1 to 3 are represented by mass % (percent by mass), and pure water was added so that the total mass of the composition came to 100% by mass.

White pigment dispersion liquid 1 contains DISCOL N-509 (nonionic polymer polyoxyethylene alkylamine, produced by Dai-ichi Kogyo Seiyaku) as the dispersant.

White pigment dispersion liquid 2 contains polyvinylpyrrolidone (nonionic resin) K-30, produced by Nippon Shokubai, as the dispersant.

White pigment dispersion liquid 3 contains an anionic dispersant DISPERBYK-102 (produced by BYK), which is a copolymer containing acid groups.

White pigment dispersion liquid 4 contains an anionic dispersant NOPCOL 5200 (produced by San Nopco), which is a polycarboxylic acid ammonium salt.

The non-white pigment dispersion liquid contains an anionic dispersant DISPERBYK-194N (produced by BYK).

For the white pigment dispersion liquids, each dispersant and a white pigment (C.I. Pigment White 6, titanium dioxide) were dispersed in a proportion of 0.2:1 in water using a ball mill containing zirconia beads for 10 hours. Subsequently, the dispersion liquid was filtered to remove coarse particles and impurities by centrifugal separation, and the white pigment content was adjusted to 40% by mass. Thus, the white pigment dispersion liquids were prepared. For the non-white pigment dispersion liquid, the dispersant and a non-white pigment C.I. Pigment Blue 15:3 were dispersed in a proportion of 0.5:1 in water in the same manner as above.

Resin particles 1 are those of a nonionic urethane resin SUPERFLEX E-2000 (produced by Dai-ichi Kogyo Seiyaku).

Resin particles 2 are those of a nonionic acrylic resin MOWINYL 7470 (produced by Japan Coating Resin Corporation).

Resin particles 3 are those of a resin emulsion (resin particle dispersion) prepared by emulsion polymerization of a mixture of 75 parts by mass of styrene, 14.2 parts by mass of methyl methacrylate, 10 parts by mass of cyclohexyl methacrylate, and acrylic acid. For the emulsion polymerization, a surfactant NEWCOL NT-30 (produced by Nippon Nyukazai) was used in a mass proportion of 2 parts to 100 parts of the monomers. The acid value of the resin particles was 5 mg KOH/g. To control the acid value to this value, the amount of acrylic acid was adjusted. The resin particles were anionic.

Resin particles 4 are those of the resin emulsion prepared in the same manner as in the preparation of resin particles 3, except for adjusting the amount of acrylic acid to control the acid value to 13 mg KOH/g.

Resin particles 5 are those of the resin emulsion prepared in the same manner as in the preparation of resin particles 3, except for adjusting the amount of acrylic acid to control the acid value to 20 mg KOH/g.

Other constituents presented in Tables 1 to 3, except for the compounds represented by their chemical names, are as follows:

AQ 515: aqueous wax emulsion (produced by BYK)

BYK 348: Silicone surfactant (produced by BYK)

In Tables 1 to 3, cells in each row for the pigment dispersion liquids, the resin particles, and the wax present the solid content by mass % of the corresponding pigment, resin particles, or wax, calculated using the solid content in the dispersion liquid or emulsion.

TABLE 1

| | | | White ink composition | | | | | | |
|---|---|---|---|---|---|---|---|---|---|
| | | | W1 | W2 | W3 | W4 | W5 | W6 | W7 |
| Pigment | White pigment | Nonionic | 15.0 | 15.0 | 15.0 | 15.0 | 15.0 | — | — |
| (Solids) | dispersion liquid 1 | dispersant | | | | | | | |
| | White pigment | | — | — | — | — | — | 15.0 | — |
| | dispersion liquid 2 | | | | | | | | |
| | White pigment | Anionic | — | — | — | — | — | — | 15.0 |
| | dispersion liquid 3 | dispersant | | | | | | | |
| | White pigment | | — | — | — | — | — | — | — |
| | dispersion liquid 4 | | | | | | | | |
| | Non-white pigment | | — | — | — | — | — | — | — |
| | dispersion liquid | | | | | | | | |
| Fixing | Resin particles 1 | Nonionic | 10.0 | — | — | — | — | 10.0 | 10.0 |
| resin | Resin particles 2 | | — | 10.0 | — | — | — | — | — |
| (Solids) | Resin particles 3 | 5 mg | — | — | 10.0 | — | — | — | — |
| | | KOH/g | | | | | | | |
| | Resin particles 4 | 13 mg | — | — | — | 10.0 | — | — | — |
| | | KOH/g | | | | | | | |
| | Resin particles 5 | 20 mg | — | — | — | — | 10.0 | — | — |
| | | KOH/g | | | | | | | |
| Organic | Propylene glycol | | 20.0 | 20.0 | 20.0 | 20.0 | 20.0 | 20.0 | 20.0 |
| solvent | 1,2-Hexanediol | | 4.0 | 4.0 | 4.0 | 4.0 | 4.0 | 4.0 | 4.0 |
| | 3-Methoxy-3-methyl-1-butanol | | — | — | — | — | — | — | — |
| | 3-Methoxy-N,N- | | 4.0 | 4.0 | 4.0 | 4.0 | 4.0 | 4.0 | 4.0 |
| | dimethylpropionamide | | | | | | | | |
| | 2-Pyrrolidone | | — | — | — | — | — | — | — |
| Wax | AQ515 | | 1.0 | 1.0 | 1.0 | 1.0 | 1.0 | 1.0 | 1.0 |
| pH | Triisopropanolamine | | 0.1 | 0.1 | 0.1 | 0.1 | 0.1 | 0.1 | 0.1 |
| adjuster | | | | | | | | | |
| Surfactant | BYK348 | | 0.5 | 0.5 | 0.5 | 0.5 | 0.5 | 0.5 | 0.5 |
| Water | Pure water | | Balance | Balance | Balance | Balance | Balance | Balance | Balance |
| Total | | | 100 | 100 | 100 | 100 | 100 | 100 | 100 |
| | | | | White ink composition | | | | | |
| | | | | W8 | W9 | W10 | W11 | W12 | W13 |
| | Pigment | White pigment | Nonionic | — | 15.0 | 15.0 | 10.0 | 15.0 | 15.0 |
| | (Solids) | dispersion liquid 1 | dispersant | | | | | | |
| | | White pigment | | — | — | — | — | — | — |
| | | dispersion liquid 2 | | | | | | | |
| | | White pigment | Anionic | — | — | — | — | — | — |
| | | dispersion liquid 3 | dispersant | | | | | | |
| | | White pigment | | 15.0 | — | — | — | — | — |
| | | dispersion liquid 4 | | | | | | | |
| | | Non-white pigment | | — | — | — | — | — | — |
| | | dispersion liquid | | | | | | | |
| | Fixing | Resin particles 1 | Nonionic | 10.0 | 5.0 | 15.0 | 10.0 | 10.0 | 10.0 |
| | resin | Resin particles 2 | | — | — | — | — | — | — |
| | (Solids) | Resin particles 3 | 5 mg | — | — | — | — | — | — |
| | | | KOH/g | | | | | | |
| | | Resin particles 4 | 13 mg | — | — | — | — | — | — |
| | | | KOH/g | | | | | | |
| | | Resin particles 5 | 20 mg | — | — | — | — | — | — |
| | | | KOH/g | | | | | | |

| | | | | | | | |
|---|---|---|---|---|---|---|---|
| Organic | Propylene glycol | 20.0 | 20.0 | 20.0 | 20.0 | 20.0 | 20.0 |
| solvent | 1,2-Hexanediol | 4.0 | 4.0 | 4.0 | 4.0 | 4.0 | — |
| | 3-Methoxy-3-methyl-1-butanol | — | — | — | — | — | 4.0 |
| | 3-Methoxy-N,N- | 4.0 | 4.0 | 4.0 | 4.0 | — | 4.0 |
| | dimethylpropionamide | | | | | | |
| | 2-Pyrrolidone | — | — | — | — | 4.0 | — |
| Wax | AQ515 | 1.0 | 1.0 | 1.0 | 1.0 | 1.0 | 1.0 |
| pH | Triisopropanolamine | 0.1 | 0.1 | 0.1 | 0.1 | 0.1 | 0.1 |
| adjuster | | | | | | | |
| Surfactant | BYK348 | 0.5 | 0.5 | 0.5 | 0.5 | 0.5 | 0.5 |
| Water | Pure water | Balance | Balance | Balance | Balance | Balance | Balance |

| | | | | | | |
|---|---|---|---|---|---|---|
| Total | 100 | 100 | 100 | 100 | 100 | 100 |

TABLE 2

| | | | Non-white ink composition | | |
|---|---|---|---|---|---|
| | | | C1 | C2 | C3 |
| Pigment | White pigment dispersion liquid 1 | Nonionic | — | — | — |
| (Solids) | White pigment dispersion liquid 2 | dispersant | — | — | — |
| | White pigment dispersion liquid 3 | Anionic | — | — | — |
| | White pigment dispersion liquid 4 | dispersant | — | — | — |
| | Non-white pigment dispersion liquid | | 6.0 | 6.0 | 6.0 |
| Fixing resin | Resin particles 1 | Nonionic | — | — | — |
| (Solids) | Resin particles 2 | | — | — | 6.0 |
| | Resin particles 3 | 5mg KOH/g | — | 6.0 | — |
| | Resin particles 4 | 13 mg | — | — | — |
| | | KOH/g | | | |
| | Resin particles 5 | 20 mg | 6.0 | — | — |
| | | KOH/g | | | |

| | | | | |
|---|---|---|---|---|
| Organic | Propylene glycol | 20.0 | 20.0 | 20.0 |
| solvent | 1,2-Hexanediol | 4.0 | 4.0 | 4.0 |
| | 3-Methoxy-3-methyl-1-butanol | — | — | — |
| | 3-Methoxy-N,N-dimethylpropionamide | 4.0 | 4.0 | 4.0 |
| | 2-Pyrrolidone | — | — | — |
| Wax | AQ515 | 1.0 | 1.0 | 1.0 |
| pH adjuster | Triisopropanolamine | 0.1 | 0.1 | 0.1 |
| Surfactant | BYK348 | 0.5 | 0.5 | 0.5 |
| Water | Pure water | Balance | Balance | Balance |

| | | | |
|---|---|---|---|
| Total | 100 | 100 | 100 |

TABLE 3

| | | Treatment liquid | | |
|---|---|---|---|---|
| | | R1 | R2 | R3 |
| Organic | Dipropylene glycol dimethyl | 15.0 | 15.0 | 15.0 |
| solvent | ether | | | |
| | 1,2-Hexanediol | 5.0 | 5.0 | 5.0 |
| Flocculant | Calcium acetate | 5.0 | — | — |
| | Acetic acid | — | 5.0 | — |
| | CATIOMASTER PD-7 (Solids) | — | — | 5.0 |
| Surfactant | BYK348 | 0.5 | 0.5 | 0.5 |
| Water | Pure water | Balance | Balance | Balance |

| | | | |
|---|---|---|---|
| Total | 100 | 100 | 100 |

### 4.2. Evaluation

### 4.2.1. Printing Test

An ink jet printer L-4533AW (manufactured by Seiko Epson) was modified into a line printer. The line printer was provided with primary heaters immediately downstream in the medium transport direction of the ink jet heads, as depicted in FIG. 4. More specifically, three sets of an ink jet head and a primary heater were arranged in the medium transport direction for the treatment liquid, the white ink, and the non-white ink in this order.

The printing resolution was 600×600 dpi. The application rate was 10 mg/inch² for the white ink composition and 7 mg/inch² for the non-white ink composition. The treatment liquid was applied in a proportion of 30% to the total mass of the applied ink compositions. The primary heating temperature was set as presented in Tables 4 to 6. The secondary heating temperature was varied depending on the printing medium used.

Tables 4 to 6 also present the printing media used in the Examples and Comparative Examples:

M1: Surface-treated polypropylene (OPP) film PYLEN P-2161, manufactured by Toyobo

M2: Surface-treated polyethylene terephthalate (PET) film TOYOBO ESTER Film E-5102, manufactured by Toyobo

M3: Polyvinyl chloride film Scotchcal Graphic Film IJ8150, manufactured by 3M

The secondary heating temperature was 65° C. for M1, 90° C. for M2, and 65° C. for M3.

The white ink composition, the non-white ink composition, and the treatment liquid used in each Example or Comparative Example are presented in Tables 4 to 6. These Tables also present printing orders of the ink compositions applied after the treatment liquid. In Example 1, for example, “C→W” represents that the treatment liquid, the non-white ink composition, and the white ink composition were applied in this order.

### 4.2.2. White Image Filling Degree

A superimposed pattern of a non-white (cyan) image and a white image and a pattern defined by only a white image were prepared. The superimposed pattern was placed on a white paper sheet with the white image overlying the non-white and then viewed from the white image side for evaluation as follows:

A: The white image of the superimposed pattern had no gaps exposing cyan color and was like a simple white image.

B: The white image of the superimposed pattern has no gaps exposing cyan color but was slightly cyan-tinted compared to the simple white image pattern.

C: The white image had a few gaps exposing cyan color.

D: The white image had many gaps exposing cyan color.

### 4.2.3. Lamination Resistance

Lamination resistance was evaluated. A dry lamination adhesive (base material TM-329 and curing agent CAT-8B, produced by Toyo-Morton) was applied onto the printed image with a bar coater, and a cast polypropylene (CPP) film PYLEN P1128 manufactured by Toyobo) was stuck, followed by aging at 40° C. for 48 hours. The laminate was cut into a 15 mm-wide piece. The strength of the cut piece was measured with a T-type separation test machine (universal test machine Tensilon RTG-1250A, manufactured by A&D Company). Thus, the lamination resistance was evaluated according to the following criteria.

A: 5 N/15 mm or more

B: 3 N/15 mm to less than 5 N/15 mm

C: 1 N/15 mm to less than 3 N/15 mm

D: less than 1 N/15 mm

### 4.2.4. Rub Resistance

The final printed image (printed pattern) was rubbed reciprocally 100 times at a speed of 30 times per minute with a Gakushin-type rubbing tester AB-301 (manufacture by TESTER SANGYO) under conditions where a load of 200 g was placed on a dried white cotton rubbing test cloth. The rub fastness was estimated by visual observation and evaluated according to the following criteria.

A: The pattern was not changed even by rubbing 100 times or more.

B: Some flaws were left in the pattern at a point of rubbing 100 times but did not affect the image.

C: The pattern was changed by rubbing 51 times to 99 times.

D: The pattern was changed by rubbing 50 times or less.

### 4.2.5. Non-White Image Quality

The final printed image was viewed from the non-white image side. The non-white image was evaluated according to the following criteria. The results are presented in Tables 4 to 6.

A: Inks spread uniformly across the pattern, and the image had no inconsistencies in density.

B: The image had small inconsistencies in density.

C: The image had a few large inconsistencies in density.

D: The image had many large inconsistencies in density.

### 4.2.6. Ejection Consistency

Printing was continuously performed for 2 hours. Then, the number of nozzles that failed ejection of white ink composition was counted. The ejection consistency was evaluated according to the following criteria, and the results are presented in Tables 4 to 6.

A: No nozzles that failed ejection.

B: 1% or less of the nozzles failed ejection.

C: More than 2% to 4% of the nozzles failed ejection.

D: More than 5% of the nozzles failed ejection.

### 4.2.7. Change in Volume Average Particle Size of Fixing Resin Particles

Dispersion liquids of 10 mass % of fixing resin particles in water were individually mixed with 5 mass % calcium acetate aqueous solution in the above-described proportion. The volume average particle sizes (D50) of the resin particles in the respective mixture were measure, followed by determining the change in volume average particle size as described above. The results were as follows:

Resin Particles 1: 0%

Resin Particles 2: 0%

Resin Particles 3: 9%

Resin Particles 4: 28%

Resin Particles 5: 47%

TABLE 4

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| White ink | W1 | W2 | W3 | W4 | W5 | W6 | W9 | W10 | W11 | W12 |
| Non-white ink | C1 | C1 | C1 | C1 | C1 | C1 | C1 | C1 | C1 | C1 |
| Treatment liquid | R1 | R1 | R1 | R1 | R1 | R1 | R1 | R1 | R1 | R1 |
| Printing order | C → W | C → W | C → W | C → W | C → W | C → W | C → W | C → W | C → W | C → W |
| Printing medium | M1 | M1 | M1 | M1 | M1 | M1 | M1 | M1 | M1 | M1 |
| Primary heating tem- | 25 | 25 | 25 | 25 | 25 | 25 | 25 | 25 | 25 | 25 |
| perature (° C.) | | | | | | | | | | |
| White filling degree | A | A | B | C | C | B | B | A | B | A |
| Lamination resistance | B | B | B | C | C | B | B | A | A | B |
| Rub resistance | B | B | B | B | C | B | C | A | A | C |
| Non-white image | B | B | B | B | B | B | B | B | B | B |
| quality | | | | | | | | | | |
| Ejection consistency | A | A | A | A | A | A | A | A | A | A |

TABLE 5

| | Example | Example | Example | Example | Example | Example | Example | Example | Example | Example |
|---|---|---|---|---|---|---|---|---|---|---|
| | 11 | 12 | 13 | 14 | 15 | 16 | 17 | 18 | 19 | 20 |
| White ink | W13 | W1 | W1 | W1 | W1 | W1 | W1 | W1 | W1 | W1 |
| Non-white ink | C1 | C2 | C3 | C1 | C1 | C1 | C1 | C1 | C1 | C1 |
| Treatment liquid | R1 | R1 | R1 | R2 | R3 | R1 | R1 | R1 | R1 | R1 |
| Printing order | C→W | C→W | C→W | C→W | C→W | C→W | C→W | C→W | C→W | C→W |
| Printing medium | M1 | M1 | M1 | M1 | M1 | M1 | M2 | M3 | M1 | M1 |
| Primary heating | 25 | 25 | 25 | 25 | 25 | 25 | 25 | 25 | 35 | 40 |
| temperature (° C.) | | | | | | | | | | |
| White filling degree | A | A | A | A | A | A | A | A | B | C |
| Lamination resistance | B | A | A | B | A | A | B | A | B | B |
| Rub resistance | A | B | A | B | B | A | A | A | B | B |
| Non-white image | B | C | C | C | A | B | B | B | A | A |
| quality | | | | | | | | | | |
| Ejection consistency | A | A | A | A | A | A | A | A | B | C |

TABLE 6

| | Comparative | Comparative | Comparative | Reference |
|---|---|---|---|---|
| | Example 1 | Example 2 | Example 3 | Example |
| White ink | W7 | W8 | W7 | W1 |
| Non-white ink | C1 | C1 | C1 | C1 |
| Treatment liquid | R1 | R1 | R1 | — |
| Printing order | C → W | C → W | W → C | C → W |
| Printing medium | M1 | M1 | M1 | M1 |
| Primary heating | 25 | 25 | 25 | 25 |
| temperature (° C.) | | | | |
| White filling | D | D | D | A |
| degree | | | | |
| Lamination | D | D | C | A |
| resistance | | | | |
| Rub resistance | D | D | C | A |
| Non-white image | B | B | C | D |
| quality | | | | |
| Ejection | A | A | A | A |
| consistency | | | | |

### 4.3. Evaluation Results

Examples using white ink compositions containing either nonionic dispersant produced well-filled white images. In contrast, Comparative Examples using white ink compositions containing no nonionic dispersant produced white images that were not sufficiently filled.

The subject matter disclosed herein may be implemented in substantially the same manner as any of the disclosed embodiments (for example, in terms of function, method, and results, or in terms of purpose and effect). Some elements used in the disclosed embodiments but not essential may be replaced. Implementations capable of producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

The above-described embodiments and modifications derive the following.

The white ink composition according to an aspect is an aqueous ink jet ink used for printing performed by applying a treatment liquid containing a flocculant onto a poorly absorbent or non-absorbent printing medium. The white ink composition contains a white pigment, a nonionic dispersant adapted to disperse the white pigment, and a fixing resin.

The nonionic dispersant is less likely to be affected by the flocculant in the treatment liquid. Accordingly, when a treatment liquid is applied onto a poorly absorbent or non-absorbent printing medium, a well-filled white image can be formed by applying the white ink composition.

In the white ink composition, the fixing resin may be nonionic or may have an acid value of 10.0 mg KOH/g or less.

Because the fixing resin is less likely to be affected by the flocculant in the treatment liquid, the white ink composition can form well-filled white images.

In some embodiments of the white ink composition, the dispersant may be a polymer dispersant.

In such a white ink composition, the white pigment is more satisfactorily dispersed.

In some embodiments of the white ink composition, the fixing resin may be selected from polyurethane resins and acrylic resins.

Such a white ink composition can form more firmly fixed white images with increased rub resistance.

In some embodiments of the white ink composition, the dispersant may have a structure selected from the group consisting of polyoxyalkylene structures, nitrogen-containing structures, and polyol structures.

In such a white ink composition, the white pigment is more satisfactorily dispersed.

In some embodiments of the white ink composition, the fixing resin content may be 1.0% to 15.0% relative to the total mass of the white ink composition.

Such a white ink composition can form white images with satisfactory rub resistance.

In some embodiments of the white ink composition, the white pigment content may be 5.0% to 20.0% relative to the total mass of the white ink composition, and the proportion by mass of the dispersant to the white pigment may be 10.0% to 150.0%.

In such a white ink composition, the white pigment is sufficiently dispersed, and the white ink composition can form sufficiently color-developed white images.

In some embodiments of the white ink composition, the fixing resin may be resin particles whose change in volume average particle size is 50.0% or less when the resin is mixed with a solution of calcium acetate.

Also, the fixing resin particles are less likely to aggregate in the white ink composition and contribute to forming sufficiently filled images.

In some embodiments, the white ink composition may contain a nitrogen-containing organic solvent.

Such a white ink composition exhibits an increased wettability on the printing medium and can form images with higher rub resistance.

In some embodiments, the white ink composition may contain an organic solvent having a normal boiling point of 160.0° C. to 280.0° C.

Such a white ink composition exhibits an increased wettability on the printing medium and can form quickly dried images with higher rub resistance.

In some embodiments, the white ink composition may be used for printing in which an aqueous non-white ink jet ink composition and the above-described treatment liquid are applied onto the printing medium. The treatment liquid contains a flocculant adapted to flocculate one or more components of the non-white ink composition.

In this instance, the white image layer formed with the white ink composition acts as the undercoat layer of the non-white image to satisfactorily hide the background of the final printed image. Also, the printed image is highly visible because the white image layer is sufficiently filled.

The printing method according to another aspect includes a white ink application step of applying the white ink composition onto a poorly absorbent or non-absorbent printing medium by an ink jet method, and a treatment liquid application step of applying the treatment liquid onto the printing medium.

In this printing method, the dispersant in the white ink composition is nonionic and, accordingly, less likely to be affected by the flocculant in the treatment liquid. Accordingly, even though the printing method is used for printing poorly absorbent or non-absorbent printing media, well-filled white images can be formed.

In some embodiments, the printing method may further include a non-white ink application step of applying an aqueous non-white ink jet ink composition containing a non-white pigment onto the printing medium by an ink jet method. In this instance, the white and non-white ink compositions are superimposed.

Consequently, the white image formed with the white ink composition acts as the undercoat layer of the non-white image formed with the non-white ink composition to hide the background of the final printed image. Also, the printed image is highly visible because the white image layer is sufficiently filled.

In some embodiments of the printing method, the non-white ink composition may be applied onto the printing medium to form a non-white ink composition layer, and the white ink composition is applied onto the non-white ink composition layer to form a white ink composition layer over the non-white ink layer.

Such a printing method can form printed images exhibiting high visibility when viewed from the opposite side to the printed side of the printing medium onto which the white ink and non-white ink compositions have been applied.

In some embodiment of the printing method, the white ink and non-white ink application steps may include respective heating steps of heating the ink composition on the printing medium.

In such a printing method, the non-white image quality of the final printed image is improved.

In some embodiments, the printing method may be performed by line printing.

Line printing quickly produce printed items.

In some embodiments, the printed side of the printed item produced by the printing method may be subjected to lamination before use.

The lamination film of the laminated printed item produced by the printing method is difficult to peel.

In some embodiments of the printing method, the printing medium may be a film made of a material selected from the group consisting of polyolefin resins and polyester resins.

The printing method can form well-filled white images even on such printing media, and the final printed images have high image quality.

What is claimed is:

1. An aqueous white ink jet ink composition used for printing in which a treatment liquid containing a flocculant is applied onto a poorly absorbent or non-absorbent printing medium, the white ink composition comprising:
a white pigment;
a nonionic dispersant adapted to disperse the white pigment; and
a fixing resin.

2. The white ink composition according to claim 1, wherein
the fixing resin is nonionic or has an acid value of 10.0 mg KOH/g or less.

3. The white ink composition according to claim 1, wherein
the dispersant is a polymer.

4. The white ink composition according to claim 1, wherein
the fixing resin contains a component selected from the group consisting of polyurethane resins and acrylic resins.

5. The white ink composition according to claim 1, wherein
the dispersant has a structure selected from the group consisting of polyoxyalkylene structures, nitrogen-containing structures, and polyol structures.

6. The white ink composition according to claim 1, wherein
the fixing resin content is 1.0% to 15.0% relative to the total mass of the white ink composition.

7. The white ink composition according to claim 1, wherein
the white pigment content is 5.0% to 20.0% relative to the total mass of the white ink composition, and the proportion by mass of the dispersant to the white pigment is 10.0% to 150.0%.

8. The white ink composition according to claim 1, wherein
the fixing resin is resin particles whose change in volume average particle size is 50.0% or less when the resin is mixed with a solution of calcium acetate.

9. The white ink composition according to claim 1, further comprising a nitrogen-containing organic solvent.

10. The white ink composition according to claim 1, further comprising an organic solvent having a normal boiling point of 160.0° C. to 280.0° C.

11. The white ink composition according to claim 1, wherein
the white ink composition is used for printing in which an aqueous non-white ink jet ink composition and the treatment liquid are applied onto the printing medium, the treatment liquid containing a flocculant adapted to flocculate one or more components of the non-white ink composition.

12. A printing method comprising:
a white ink application step of applying the white ink composition as set forth in claim 1 onto a poorly absorbent or non-absorbent printing medium by an ink jet method; and
a treatment liquid application step of applying the treatment liquid onto the printing medium.

13. The printing method according to claim 12, further comprising a non-white ink application step of applying an aqueous non-white ink jet ink composition containing a non-white pigment onto the printing medium by an ink jet method, wherein the white and non-white ink compositions are applied so as to be superimposed.

14. The printing method according to claim 13, wherein
the non-white ink composition is applied onto the printing medium to form a non-white ink composition layer, and the white ink composition is applied onto the non-white ink composition layer to form a white ink composition layer over the non-white ink layer.

15. The printing method according to claim 13, wherein
the white ink application step and the non-white ink application step include respective heating steps of heating the ink composition applied onto the printing medium.

16. The printing method according to claim 12, wherein
the ink jet method is performed in a line ink jet manner.

17. The printing method according to claim 12, wherein
the printing method produces a printed item whose printed side is to be subjected to lamination before use.

18. The printing method according to claim 12, wherein
the printing medium is a film made of a material selected from the group consisting of polyolefin resins and polyester resins.
